(19) United States
(12) Patent Application Publication
(10) Pub. No.: US 2026/0361862 A1
(43) Pub. Date: Nov. 12, 2026

(54) VIDEO DECODING METHOD, VIDEO ENCODING METHOD, DECODER, ENCODER, AND COMPUTER-READABLE STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(21) Appl. No.: 19/735,842

(22) Filed: Jul. 9, 2026

Related U.S. Application Data
(63) Continuation of application No. PCT/CN2024/071469, filed on Jan. 9, 2024.

(51) Int. Cl. H04N 19/117; H04N 19/136; H04N 19/176; H04N 19/186; H04N 19/70; H04N 19/82

(52) U.S. Cl. CPC H04N 19/117; H04N 19/136; H04N 19/176; H04N 19/186; H04N 19/70; H04N 19/82

(57) ABSTRACT

Embodiments of the present disclosure provide a video decoding method. The method includes: performing feature extraction based on a reconstructed picture block corresponding to a current block through a preprocessing part in a preset filtering network, to determine an initial feature; where a feature channel number of the preprocessing part is a preset value; performing feature extraction based on the initial feature through a preset number of backbone networks in the preset filtering network, to determine an intermediate feature; and determining a filtered picture block corresponding to the current block according to the intermediate feature through an output part in the preset filtering network.

### CROSS-REFERENCE TO RELATED APPLICATION

This application is a Continuation application of International Application No. PCT/CN2024/071469 filed on Jan. 9, 2024, which is incorporated herein by reference in its entirety.

### TECHNICAL FIELD

Embodiments of the present disclosure relate to video encoding and decoding technologies, and relate to, but are not limited to, a video encoding method, a video decoding method, a decoder, an encoder, and a computer-readable storage medium.

### BACKGROUND

Currently, neural network-based loop filtering solutions have relatively high complexity, which makes them only applicable to some high-performance terminals and difficult to implement on some general devices or terminals not equipped with a neural network processing unit (Neural Processing Unit, NPU) chip.

Therefore, the current neural network-based loop filtering solutions have relatively high complexity, thereby reducing the widespread application of the neural network-based filtering solutions.

### SUMMARY

Embodiments of the present disclosure provide a video encoding method, a video decoding method, a decoder, an encoder, and a computer-readable storage medium.

In a first aspect, the embodiments of the present disclosure provide a video decoding method, the method including:
performing feature extraction based on a reconstructed picture block corresponding to a current block through a preprocessing part in a preset filtering network, to determine an initial feature; where a feature channel number of the preprocessing part is a preset value;
performing feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters; and
determining a filtered picture block corresponding to the current block according to the intermediate feature through an output part in the preset filtering network.

In a second aspect, the embodiments of the present disclosure provide an encoding method, the method including:
performing feature extraction based on a reconstructed picture block corresponding to a current block through a preprocessing part in a preset filtering network, to determine an initial feature; where a feature channel number of the preprocessing part is a preset value;
performing feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters; and
determining a filtered picture block corresponding to the current block according to the intermediate feature through an output part in the preset filtering network.

In a third aspect, the embodiments of the present disclosure provide a decoder, including:
a first feature preprocessing part, configured to perform feature extraction based on a reconstructed picture block corresponding to a current block through a preprocessing part in a preset filtering network, to determine an initial feature; where a feature channel number of the preprocessing part is a preset value;
a first intermediate feature extraction part, configured to perform feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters;
a first filtering output part, configured to determine a filtered picture block corresponding to the current block according to the intermediate feature through an output part in the preset filtering network.

In a fourth aspect, the embodiments of the present disclosure provide an encoder, including:
a second feature preprocessing part, configured to perform feature extraction based on a reconstructed picture block corresponding to a current block through a preprocessing part in a preset filtering network, to determine an initial feature; where a feature channel number of the preprocessing part is a preset value;
a second intermediate feature extraction part, configured to perform feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters;
a second filtering output part, configured to determine a filtered picture block corresponding to the current block according to the intermediate feature through an output part in the preset filtering network.

In a fifth aspect, the embodiments of the present disclosure provide a decoder, including:
a first memory, configured to store executable instructions;
a first processor, configured to, upon executing the executable instructions stored in the first memory, implement the video decoding method in the embodiments of the present disclosure.

In a sixth aspect, the embodiments of the present disclosure provide an encoder, including:
a second memory, configured to store executable instructions;
a second processor, configured to, upon executing the executable instructions stored in the second memory, implement the video encoding method provided in the embodiments of the present disclosure.

The embodiments of the present disclosure provide a bitstream, where the bitstream is generated by performing bit encoding according to to-be-encoded information; where the to-be-encoded information at least includes at least one of the following:
encoding information of a current picture;
where the encoding information of the current picture is determined by performing inter prediction based on a historical filtered picture block; the historical filtered picture block is determined by filtering a historical block in a historical picture through a preset filtering network, including:
performing feature extraction based on a historical reconstructed picture block corresponding to the historical block through a preprocessing part in the preset filtering network, to determine a historical initial feature; where a feature channel number of the preprocessing part is a preset value;
performing feature extraction based on the historical initial feature through a preset number of backbone networks in the preset filtering network, to determine a historical intermediate feature; where the preset value is less than a feature channel number used for input data feature extraction in HOP.2 and LOP.2 filters; and/or the preset number is less than a number of backbone network layers in the HOP.2 and LOP.2 filters;
determining the historical filtered picture block according to the historical intermediate feature through an output part in the preset filtering network.

### BRIEF DESCRIPTION OF THE DRAWINGS

FIG. 1 is a schematic diagram of a component block diagram of a current HOP.2 filter.

FIG. 2 is a schematic diagram of a component block diagram of a current LOP.2 filter.

FIG. 3 is a schematic diagram of a component block diagram of an encoder provided in the embodiments of the present disclosure.

FIG. 4 is a schematic diagram of a component block diagram of a decoder provided in the embodiments of the present disclosure.

FIG. 5 is a schematic diagram of a network architecture of an encoding and decoding system provided in the embodiments of the present disclosure.

FIG. 6 is an optional schematic flowchart of an encoding method provided in the embodiments of the present disclosure.

FIG. 7 is an optional schematic structural diagram of a preset filtering network provided in the embodiments of the present disclosure.

FIG. 8 is an optional schematic structural diagram of a preset filtering network provided in the embodiments of the present disclosure.

FIG. 9 is an optional schematic structural diagram of a preset filtering network provided in the embodiments of the present disclosure.

FIG. 10 is an optional schematic structural diagram of a preset filtering network provided in the embodiments of the present disclosure.

FIG. 11 is an optional schematic structural diagram of a backbone network module provided in the embodiments of the present disclosure.

FIG. 12 is an optional schematic structural diagram of a preset filtering network provided in the embodiments of the present disclosure.

FIG. 13 is an optional schematic structural diagram of a backbone network module provided in the embodiments of the present disclosure.

FIG. 14 is an optional schematic structural diagram of a preset filtering network provided in the embodiments of the present disclosure.

FIG. 15 is an optional schematic structural diagram of a first backbone network module or a second backbone network module provided in the embodiments of the present disclosure.

FIG. 16 is an optional schematic structural diagram of a preset filtering network provided in the embodiments of the present disclosure.

FIG. 17 is an optional schematic structural diagram of a first backbone network module provided in the embodiments of the present disclosure.

FIG. 18 is an optional schematic structural diagram of a second backbone network module provided in the embodiments of the present disclosure.

FIG. 19 is an optional schematic structural diagram of a preset filtering network provided in the embodiments of the present disclosure.

FIG. 20 is an optional schematic flowchart of a decoding method provided in the embodiments of the present disclosure.

FIG. 21 is a first schematic structural diagram of a decoder provided in the embodiments of the present disclosure.

FIG. 22 is a second schematic structural diagram of a decoder provided in the embodiments of the present disclosure.

FIG. 23 is a first schematic structural diagram of an encoder provided in the embodiments of the present disclosure.

FIG. 24 is a second schematic structural diagram of an encoder provided in the embodiments of the present disclosure.

### DETAILED DESCRIPTION

The technical solutions in the embodiments of the present disclosure will be clearly and completely described below in conjunction with the drawings in the embodiments of the present disclosure. It may be understood that the specific embodiments described herein are only used to explain the related disclosure, rather than to limit the disclosure. In addition, it should be noted that, for ease of description, only parts related to the relevant disclosure are shown in the drawings.

It should be noted that “first”, “second”, “third”, etc., mentioned throughout the specification are only used to distinguish different features and do not have the functions of limiting the priority, order, size relationship, etc.

Nouns and terms involved in the embodiments of the present disclosure are explained, and the nouns and terms involved in the embodiments of the present disclosure are applicable to the following explanations:
H.266/VVC: Versatile Video Coding (VVC);
Joint Video Experts Team (JVET);
Neural-Network based Video Coding (NNVC);
Deblocking Filter (DBF);
Sample Adaptive Offset (SAO);
Adaptive Loop Filter (ALF);
Coding Unit (CU); and
Coding Tree Unit (CTU).

Current universal video encoding and decoding standards (such as H.266/VVC) all adopt a block-based hybrid coding framework. Each frame in a video is partitioned into square largest coding units (LCU) of the same size (such as 128×128, 64×64, etc.). Each largest coding unit may be partitioned into rectangular coding units (CU) according to a rule. The coding unit may also be partitioned into a prediction unit (PU), a transform unit (TU), etc. The hybrid coding framework includes modules such as prediction, transform, quantization, entropy coding, and in loop filter, etc. The prediction module includes intra prediction and inter prediction. Inter prediction includes motion estimation and motion compensation. Because there is a strong correlation between adjacent pixels in a frame of the video, the intra prediction method is used in the video encoding and decoding technology to eliminate spatial redundancy between adjacent pixels. Because there is a strong similarity between adjacent frames in the video, the inter prediction method is used in the video encoding and decoding technology to eliminate temporal redundancy between adjacent frames, thereby improving coding efficiency.

The basic flow of a video codec is as follows. At the encoder side, a frame of the picture is partitioned into blocks, intra prediction or inter prediction is used for a current block to generate a prediction block of the current block, an original picture block of the current block is subtracted by the prediction block to obtain a residual block, the residual block is transformed and quantized to obtain a quantized coefficient matrix, and the quantized coefficient matrix is entropy encoded and output into a bitstream. At the decoder, intra prediction or inter prediction is used for the current block to generate a prediction block of the current block; on the other hand, the bitstream is parsed to obtain a quantized coefficient matrix, the quantized coefficient matrix is inversely quantized and inversely transformed to obtain a residual block, and the prediction block and the residual block are added to obtain a reconstructed block. The reconstructed blocks form a reconstructed picture, and loop filtering is performed on the reconstructed picture based on the picture or based on the block, to obtain a decoded picture. The encoder side also needs an operation similar to that of the decoder to obtain the decoded picture. The decoded picture may be used as a reference frame for inter prediction for a subsequent frame. If necessary, block partition information, mode information or parameter information such as prediction, transform, quantization, entropy encoding, and loop filtering, etc., determined by the encoder side, need to be output into the bitstream. The decoder determines, through parsing and analysis according to existing information, the same block partition information, mode information or parameter information such as prediction, transform, quantization, entropy encoding, and loop filtering, etc., as those at the encoder side, thereby ensuring that the decoded picture obtained by the encoder side is the same as the decoded picture obtained by the decoder. The decoded picture obtained by the encoder side is usually also referred to as a reconstructed picture. During prediction, the current block may be partitioned into prediction units; during transform, the current block may be partitioned into transform units; the divisions of the prediction units and the transform units may be different. The above is the basic flow of a video codec under the block-based hybrid coding framework; with the development of technologies, some modules or steps of this framework or flow may be optimized. The current block may be a current coding unit (CU) or a current prediction unit (PU), etc.

Currently, deep learning and neural networks are hot spots in various industries, especially in the field of computer vision, methods based on deep learning often have overwhelming advantages. By virtue of the powerful learning ability of the neural network, neural network-based coding tools often have very efficient coding efficiency. Herein, the neural network-based loop filtering method has the most outstanding coding performance, and the coding performance can reach more than 10%.

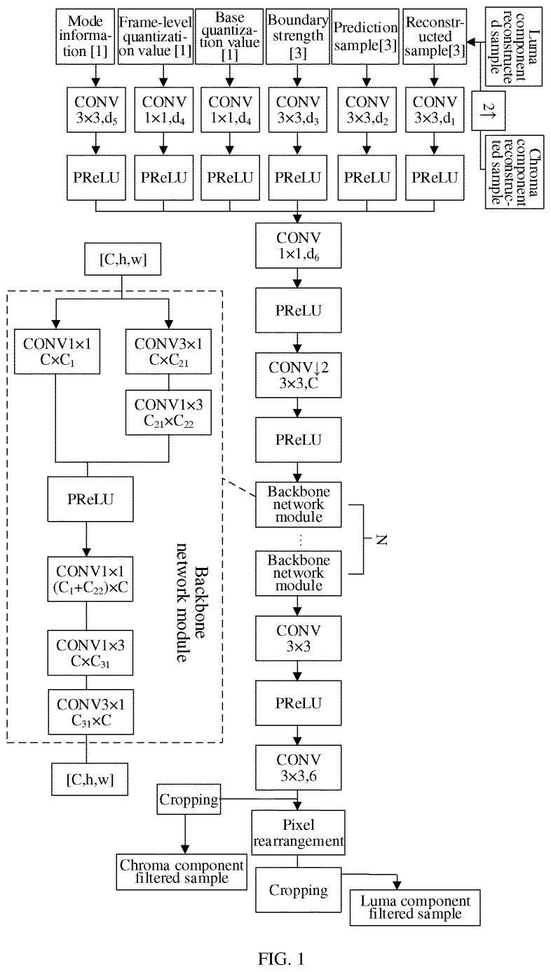

The neural network-based loop filtering solution is applied in loop filtering to improve the quality of a reconstructed picture. Currently, a neural network-based loop filtering model (High Operation Point, HOP.2) in JVET may be as shown in FIG. 1.

In FIG. 1, regarding the input part, it mainly includes a reconstructed sample rec, a prediction sample pred, boundary strength BS, mode information IPB, and a quantization parameter QP, etc. Herein, the boundary strength may be understood as strength information detected based on a deblocking filter, the mode information indicates intra prediction I, unidirectional inter prediction P, and bidirectional inter prediction B is used for the coding block in which the sample is located, and finally, the quantization parameter includes a base quantization value BaseQP and a frame-level quantization value SliceQP. In FIG. 1, CONV represents a convolution module; d₁ to d₆ represent a feature channel number of the corresponding convolution module, and 3×3 or 1×1 represents a convolution kernel size of the corresponding convolution module. PReLU represents a ReLU activation function with a learnable parameter P. FIG. 1 includes N backbone network modules (Back Bone Block) connected in series, and the network structure of each backbone network module may be as shown in the dashed box in FIG. 1. [C, h, w] represents feature values of a feature input to the backbone network module in three feature dimensions, C represents the feature channel number, h represents height, and w represents width; C×C₁, C×C₂₁, C₂₁×C₂₂, (C₁+C₂₂)×C, C×C₃₁, C₃₁×C, etc., are feature channel numbers of the corresponding convolution module in different feature dimensions. The feature channel number of CONV←2 is C. FIG. 1 is a single network model, i.e., a single model is used to process different color components and different frame types. Therefore, the input information also includes different color components of the above input part, such as a luma component reconstructed sample and chroma component reconstructed sample in a YUV domain; or, it may also include a luma component prediction sample, chroma component prediction sample, etc. For FIG. 1, N is generally 24.

Regarding the output part of FIG. 1, based on the description of the above input part, the input includes different color components, then the output part also includes different color components, i.e., a luma component filtered sample filteredRec and chroma component filtered sample filterRec.

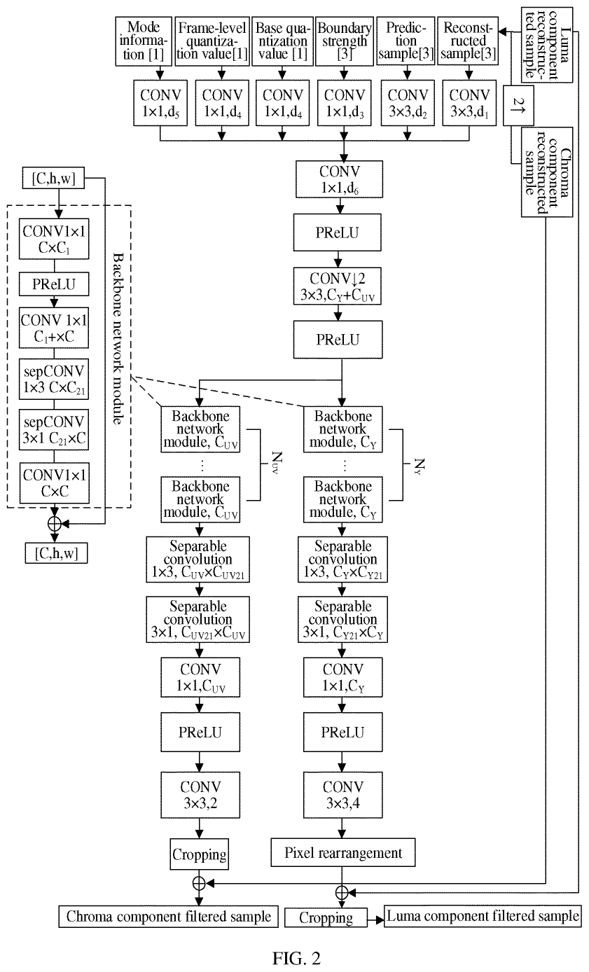

Currently, another neural network-based loop filtering model (Low Operation Point, LOP.2) in JVET may be as shown in FIG. 2. The difference from FIG. 1 is that, in FIG. 1, the neural network loop filtering has no difference in the processing of the luma component and chroma component in the main framework, i.e., uses the Backbone Block of the same path for feature extraction and filtering. However, in FIG. 2, the main framework of the neural network loop filtering processes the luma component and the chroma component separately, i.e., the complexity of the corresponding component may be increased or decreased according to resource conditions, so as to achieve the purpose of resource allocation optimization. As shown in FIG. 2, after input fusion, the information of the luma component enters a luma channel, and the number of Backbone Blocks of the luma channel is determined by N_{Y}; similarly, the network depth of the chroma channel is determined by N_{UV}; the design of different complexities for the luma channel and the chroma channel also makes the network have a preference for the filtering capability of luma and chroma. For a video in a YUV420 format, video encoding and decoding pays more attention to the compression gain of the luma component, so this model can better obtain the benefit of the luma component under a low complexity condition.

For a neural network-type tool, a currently more commonly used complexity measurement method is to calculate the number of multiplications of the model, and the neural network-based tool in video encoding and decoding also adopts the similar measurement method. The complexity of the number of multiplications is represented by combining per minimum unit pixel in the picture, to obtain a KMAC/pixel complexity representation. KMAC/pixel is used to measure the computational complexity based on a neural network tool in the encoding and decoding processes, KMAC represents kilo multiply-accumulate operations, and KMAC/pixel is the number of kilo multiply-accumulate operations required per pixel by the neural network tool.

The neural network-based loop filtering solutions in JVET in the above FIG. 1 and FIG. 2 both have relatively high complexity, and have multiplication number requirements ranging from 17 KMAC to 477KMAC, in the complexity calculation method using KMAC as the measurement. Currently, the NPU chip capability on mainstream mobile phones is between 10 to 20 TOPs, which can roughly have a processing capability of 20 to 30 KMAC/pixel after conversion to KMAC. It should be noted that it is assumed that one OP of these NPU chips can complete one convolution multiplication calculation. Therefore, the above neural network tool can only be applied on some high-performance flagship mobile phones, and some ordinary devices or terminals not equipped with NPU chips cannot apply the above neural network-based filtering tool.

To sum up, the current neural network-based loop filtering solution in JVET, such as HOP.2 or LOP.2 filters, has excessively high complexity, thereby reducing the widespread application of the neural network-based loop filter.

The embodiments of the present disclosure provide a video encoding method, a video decoding method, a decoder, an encoder, and a computer-readable storage medium, which can achieve high encoding and decoding compression performance on the basis of reducing the complexity of loop filtering. The embodiments of the present disclosure will be described in detail below in conjunction with the drawings.

Referring to FIG. 3, a schematic diagram of a component block diagram of an encoder provided in the embodiments of the present disclosure is shown. As shown in FIG. 3, the encoder (specifically a “video encoder”) 50 may include a transform and quantization unit 501, an intra estimation unit 502, an intra prediction unit 503, an inter prediction unit 504, a motion estimation unit 505, an inverse transform and inverse quantization unit 506, a filter control analysis unit 507, a filtering unit 508, an encoding unit 509, and a decoded picture buffer unit 510, etc., where the filtering unit 508 may implement deblocking filtering and sample adaptive offset (Sample Adaptive Offset, SAO) filtering, and the encoding unit 509 may implement header information encoding and context-based adaptive binary arithmetic coding (Context-based Adaptive Binary Arithmetic Coding, CABAC). For the input original video signal, a video coding block may be obtained through partition of a coding tree unit (Coding Tree Unit, CTU), and then for residual pixel information obtained from intra or inter prediction, the video coding block is transformed through the transform and quantization unit 501, including transforming the residual information from a pixel domain to a transform domain and quantizing the obtained transform coefficient, to further reduce the bit rate; the intra estimation unit 502 and the intra prediction unit 503 are used to perform intra prediction on the video coding block; specifically, the intra estimation unit 502 and the intra prediction unit 503 are used to determine an intra prediction mode to be used to encode the video coding block; the inter prediction unit 504 and the motion estimation unit 505 are used to perform inter prediction encoding of the received video coding block relative to one or more blocks in one or more reference frames, to provide temporal prediction information; the motion estimation performed by the motion estimation unit 505 is a process of generating a motion vector, the motion vector may estimate the motion of the video coding block, and then the inter prediction unit 504 performs motion compensation based on the motion vector determined by the motion estimation unit 505, so the inter prediction unit 504 may also be referred to as a motion compensation unit; after determining the intra prediction mode, the intra prediction unit 503 is further used to provide the selected intra prediction data to the encoding unit 509, and the motion estimation unit 505 also sends the calculated and determined motion vector data to the encoding unit 509; in addition, the inverse transform and inverse quantization unit 506 is used for reconstruction of the video coding block, by reconstructing a residual block in the pixel domain, and the blocking artifact is removed from the reconstructed residual block through the filter control analysis unit 507 and the filtering unit 508, and then the reconstructed residual block is added to a prediction block in a frame of the decoded picture buffer unit 510, to generate a reconstructed video coding block; the encoding unit 509 is used to encode various encoding parameters and quantized transform coefficients; in the CABAC-based encoding algorithm, context content may be based on adjacent coding blocks, and may be used to encode information indicating the determined intra prediction mode, and output a bitstream of the video signal; and the decoded picture buffer unit 510 is used to store the reconstructed video coding block for prediction reference. As the video picture encoding proceeds, new reconstructed video coding blocks are continuously generated, and these reconstructed video coding blocks are all stored in the decoded picture buffer unit 510.

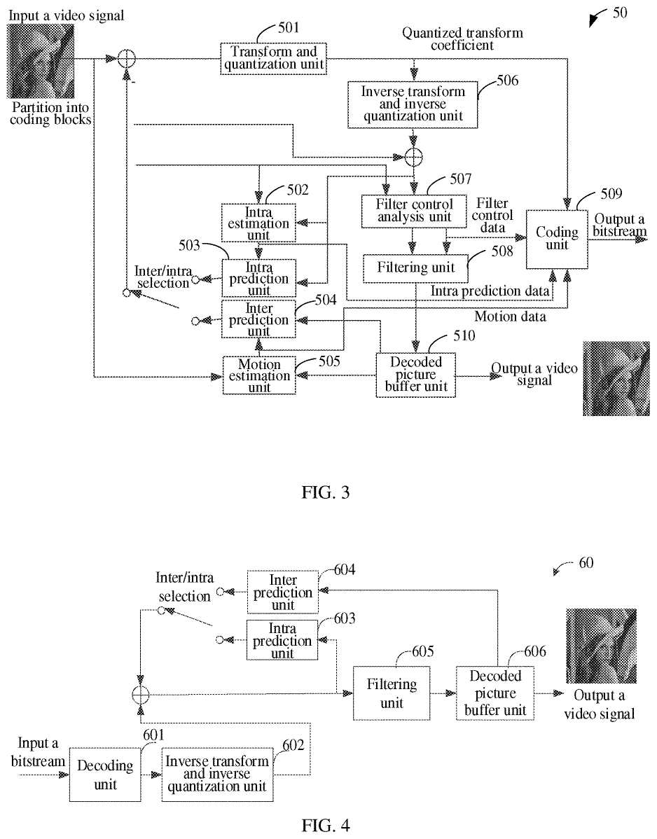

Referring to FIG. 4, a schematic diagram of a component block diagram of a decoder provided in the embodiments of the present disclosure is shown. As shown in FIG. 4, the decoder (specifically a “video decoder”) 60 includes a decoding unit 601, an inverse transform and inverse quantization unit 602, an intra prediction unit 603, an inter prediction unit 604, a filtering unit 605, and a decoded picture buffer unit 606, etc, where the decoding unit 601 may implement header information decoding and CABAC decoding, and the filtering unit 605 can implement deblocking filtering and SAO filtering. After the encoding processing of FIG. 3 is performed on the input video signal, the bitstream of the video signal is output; the bitstream is input into the decoder 60, first passes through the decoding unit 601 to obtain decoded transform coefficients; the transform coefficients are processed by the inverse transform and inverse quantization unit 602 to generate a residual block in the pixel domain; the intra prediction unit 603 may be used to generate prediction data of the current video decoding block based on the determined intra prediction mode and data from previously decoded blocks of the current frame or picture; the inter prediction unit 604 determines prediction information for the video decoding block by parsing a motion vector and other associated syntax elements, and uses the prediction information to generate a prediction block of the video decoding block being decoded; the decoded video block is formed by summing the residual block from the inverse transform and inverse quantization unit 602 and the corresponding prediction block generated by the intra prediction unit 603 or the inter prediction unit 604; the decoded video signal passes through the filtering unit 605 to remove blocking artifacts, which may improve video quality; then the decoded video block is stored in the decoded picture buffer unit 606, which stores a reference picture for subsequent intra prediction or motion compensation, and is also used for output of the video signal, i.e., the restored original video signal is obtained.

Furthermore, the embodiments of the present disclosure also provide a network architecture of an encoding and decoding system including an encoder and a decoder. FIG. 5 is a schematic diagram of a network architecture of an encoding and decoding system provided in the embodiments of the present disclosure. As shown in FIG. 5, the network architecture includes one or more electronic devices 13 to 1N and a communication network 01, where the electronic devices 13 to 1N may perform video interaction through the communication network 01. The electronic devices may be various types of devices with video encoding and decoding functions during implementations. For example, the electronic devices may include smart phones, tablet computers, personal computers, personal digital assistants, navigators, digital phones, video phones, televisions, sensor devices, servers, etc., which are not specifically limited in the embodiments of the present disclosure. Herein, the decoder or encoder described in the embodiments of the present disclosure may be the above electronic device.

It should be noted that the methods of the embodiments of the present disclosure are mainly applied to the filtering unit 508 part shown in FIG. 3 and the filtering unit 605 part shown in FIG. 4. That is, the embodiments of the present disclosure may be applied to an encoder, a decoder, or even both the encoder and the decoder simultaneously, but the embodiments of the present disclosure do not impose specific limitations on this.

It should also be noted that when applied to the filtering unit 508 part, the “current block” specifically refers to a current encoding block; when applied to the filtering unit 605 part, the “current block” specifically refers to a current decoding block. The filtering unit 508 part and the filtering unit 605 part may include a neural network loop filtering algorithm-based filtering unit.

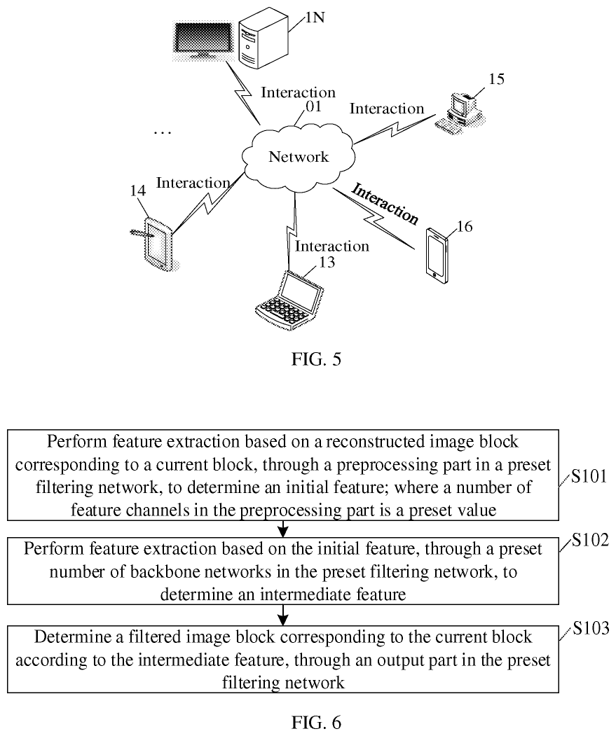

In an embodiment of the present disclosure, referring to FIG. 6, a schematic flowchart of an encoding method provided in the embodiments of the present disclosure is shown. The method may include S101 to S103.

In S101: perform feature extraction based on a reconstructed picture block corresponding to a current block through a preprocessing part in a preset filtering network, to determine an initial feature; where a feature channel number of the preprocessing part is a preset value.

In S101, the encoder performs prediction, transform, quantization, and inverse quantization and inverse transform on the current block to determine a reconstructed picture block corresponding to the current block. In some embodiments, the current block may be a current coding unit (CU), a current transform unit (TU), a current prediction unit (PU), a current coding block (CB), etc., which are not specifically limited in the embodiments of the present disclosure.

In S101, the above neural network loop filtering algorithm-based filtering unit may be implemented as a preset filtering network. The preset filtering network includes a preprocessing part, a preset number of backbone networks, and an output part. Herein, the preprocessing part is used to extract an initial feature from input data; the preset number of backbone networks are used to perform deep feature extraction based on the initial feature to determine an intermediate feature; and the output part is used to determine a filtered picture block based on the extracted intermediate feature.

In some embodiments, the preprocessing part includes at least one group of first convolution parts, and a second convolution part. Herein, the at least one group of first convolution parts corresponds to at least one type of input data of the preset filtering network. Each group of first convolution parts is used to perform feature extraction on one type of input data among the at least one type of input data, to obtain an input feature corresponding to the input data. The at least one type of input data includes at least a reconstructed picture block. The second convolution part is used to merge the input features corresponding to each type of input data and perform feature extraction to determine the initial feature.

In some embodiments, the first convolution part includes a first convolution module; the second convolution part includes at least one group of second convolution modules and a second activation function. S101 may be implemented through the following process.
performing feature extraction on the at least one type of input data through the at least one group of first convolution parts, to determine at least one input feature; and merging the at least one input feature through the second convolution part, and performing at least one feature extraction based on a merged input feature to determine the initial feature. Herein, the above preset value may include: a preset feature channel number of at least one first convolution module and/or a preset feature channel number of the second convolution module. Among the at least one first convolution module, the preset feature channel number of each convolution module is less than a feature channel number of the convolution module in HOP.2 and LOP.2 filters. The preset feature channel number of the second convolution module is less than a feature channel number of a corresponding convolution module in the HOP.2 and LOP.2 filters. Exemplarily, the second convolution module may correspond to the convolution module (lxi, d₆) and the convolution module (3×3, C) in the HOP.2 filter of FIG. 1 or the LOP.2 filter of FIG. 2; for the convolution module (lxi, d₆), the preset feature channel number of the second convolution module is less than d₆; for the convolution module (3×3, C), the preset feature channel number of the second convolution module is less than C, or the preset feature channel number of the second convolution module is less than C_{Y}+C_{UV}.

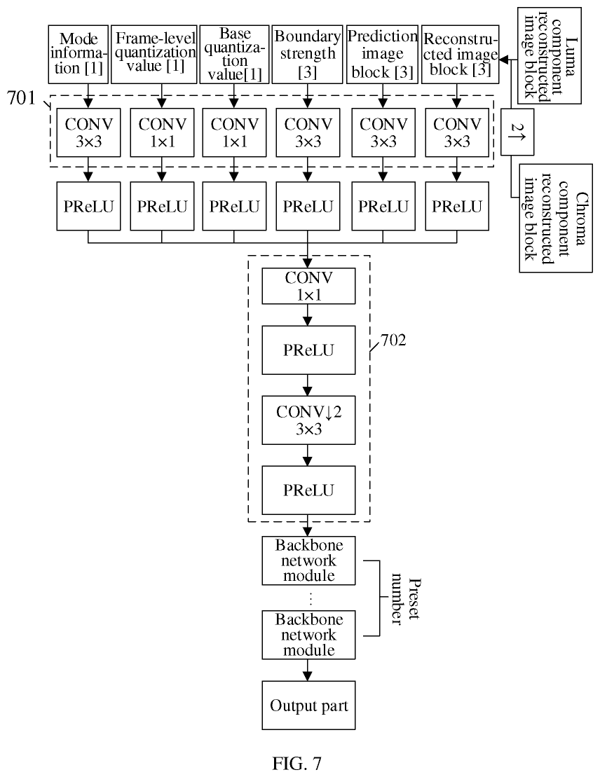

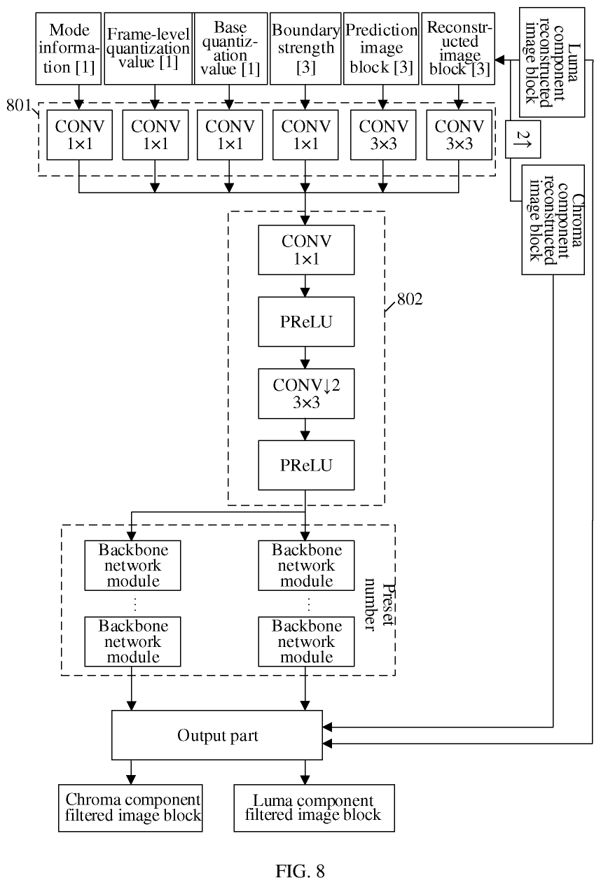

In some embodiments, the at least one type of input data includes at least one of a reconstructed picture block, a prediction picture block, boundary strength, a quantization parameter, or mode information; correspondingly, the at least one first convolution module includes at least one of a first convolution module corresponding to the reconstructed picture block, a first convolution module corresponding to the prediction picture block, a first convolution module corresponding to the boundary strength, a first convolution module corresponding to the quantization parameter, or a first convolution module corresponding to the mode information. Exemplarily, the at least one group of first convolution modules may be as shown in part 701 in FIG. 7, and the second convolution module may be as shown in part 702 in FIG. 7. Alternatively, the at least one group of first convolution modules may be as shown in part 801 in FIG. 8, and the second convolution module may be as shown in part 802 in FIG. 8. Herein, the first convolution module corresponding to the quantization parameter includes a first convolution module corresponding to a frame-level quantization value and a first convolution module corresponding to a base quantization value. The at least one group of first convolution parts in FIG. 7 may include a first convolution module and a first activation function (e.g., PReLU) module.

Based on FIG. 7 or FIG. 8, the preset feature channel number of the first convolution module corresponding to the reconstructed picture block is a first value; the first value is less than a feature channel number of a convolution module used for performing feature extraction on the reconstructed picture block in the HOP.2 and LOP.2 filters. Exemplarily, the feature channel number of the convolution module used for performing feature extraction on the reconstructed picture block in the HOP.2 and LOP.2 filters may be the value of d₁ in FIG. 1 and FIG. 2.

And/or, the preset feature channel number of the first convolution module corresponding to the prediction picture block is a second value; the second value is less than a feature channel number of a convolution module used for performing feature extraction on the prediction sample in the HOP.2 and LOP.2 filters. Exemplarily, the feature channel number of the convolution module used for performing feature extraction on the prediction picture block in the HOP.2 and LOP.2 filters may be the value of d₂ in FIG. 1 and FIG. 2.

And/or, the preset feature channel number of the first convolution module corresponding to the boundary strength is a third value; the third value is less than a feature channel number of a convolution module used for performing feature extraction on the boundary strength in the HOP.2 and LOP.2 filters. Exemplarily, the feature channel number of the convolution module used for performing feature extraction on the boundary strength in the HOP.2 and LOP.2 filters may be the value of d₃ in FIG. 1 and FIG. 2.

And/or, the preset feature channel number of the first convolution module corresponding to the quantization parameter is a fourth value; the fourth value is less than a feature channel number of a convolution module used for performing feature extraction on the quantization parameter in the HOP.2 and LOP.2 filters. Exemplarily, the feature channel number of the convolution module used for performing feature extraction on the quantization parameter in the HOP.2 and LOP.2 filters may be the value of d₄ in FIG. 1 and FIG. 2.

And/or, the preset feature channel number of the first convolution module corresponding to the mode information is a fifth value; the fifth value is less than a feature channel number of a convolution module used for performing feature extraction on the mode information in the HOP.2 and LOP.2 filters. Exemplarily, the feature channel number of the convolution module used for performing feature extraction on the mode information in the HOP.2 and LOP.2 filters may be the value of d₅ in FIG. 1 and FIG. 2.

It should be noted that the applicant has found through experiments that reducing the types of input information has little impact on the capability of the network model. Exemplarily, the boundary strength or the prediction picture block may be removed from the at least one input data, which helps to further reduce the complexity of the network model, and meanwhile, reduces the overhead of hardware implementations.

In S102: perform feature extraction based on the initial feature through a preset number of backbone networks in the preset filtering network, to determine an intermediate feature.

In the embodiments of the present disclosure, the preset number of backbone networks in the preset filtering network is equivalent to a preset number of backbone network layers, an input of a first backbone network among the preset number of backbone networks is connected to an output of the preprocessing part; an input of an i-th backbone network is connected to an output of an (i−1)-th backbone network (i is an integer greater than 1), and an output of a last backbone network is connected to the output part in the preset filtering network. In this way, through the preset number of backbone networks, layer-by-layer feature extraction is performed based on the initial feature output by the preprocessing part, and deeper feature information, which is determined as the intermediate feature, is extracted from the initial feature.

In the embodiments of the present disclosure, the above preset value is less than a feature channel number used for input data feature extraction in the HOP.2 and LOP.2 filters; and/or the above preset number is less than a number of backbone network layers in the HOP.2 and LOP.2 filters. That is, the feature channel number of the preprocessing part is less than the feature channel number used for input data feature extraction in the HOP.2 and LOP.2 filters; and/or the number of backbone network layers is less than the number of backbone network layers in the HOP.2 and LOP.2 filters.

The applicant has found through experiments that for the at least one first convolution module or the second convolution part in the preprocessing part, the feature channel number has a small impact on the quality of the subsequently to-be-filtered picture, so the feature channel number of the preprocessing part may be optimized to reduce the complexity of the entire filtering network. And/or, based on FIG. 1 and FIG. 2, it can be seen that the backbone network module includes multiple layers of convolution modules. Therefore, reducing the number of backbone network modules, i.e., reducing the number of the backbone network module layers, may greatly reduce the complexity of the entire filtering network. In practical applications, the feature channel number of the preprocessing part may be set to a preset value, or the number of backbone networks may be set to a preset number, or both the feature channel number of the preprocessing part may be set to the preset value and the number of backbone networks may be set to the preset number, etc., to reduce the complexity of the entire filtering network; the specific selection may be made according to actual situations, which is not limited in the embodiments of the present disclosure.

In S103: determine a filtered picture block corresponding to the current block according to the intermediate feature through an output part in the preset filtering network.

In S103, prediction is performed according to the intermediate feature through the output part of the preset filtering network, thereby completing the filtering of the current block to determine the filtered picture block corresponding to the current block.

In some embodiments, the output part may include a feature extraction part and an inference part; further feature extraction is performed on the intermediate feature through the feature extraction part, and prediction is performed according to the further extracted feature, to determine the filtered picture block.

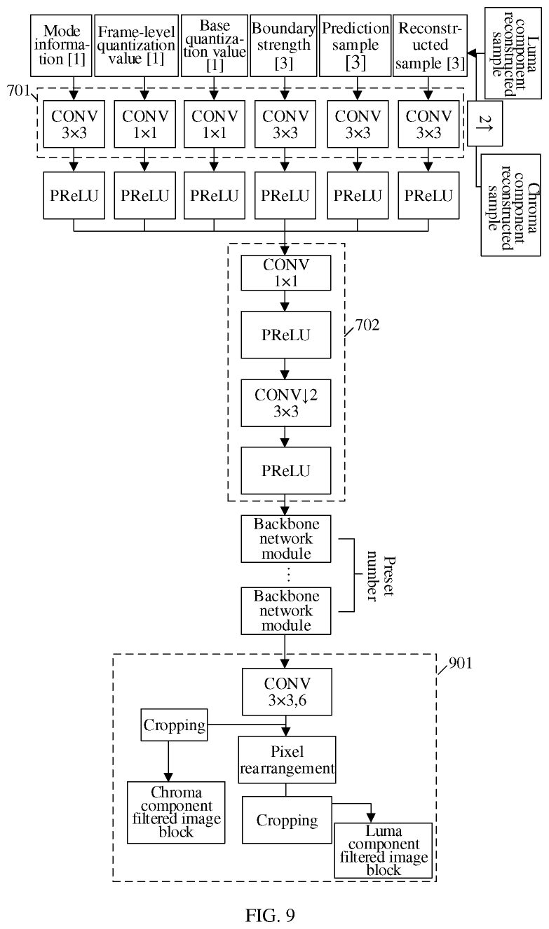

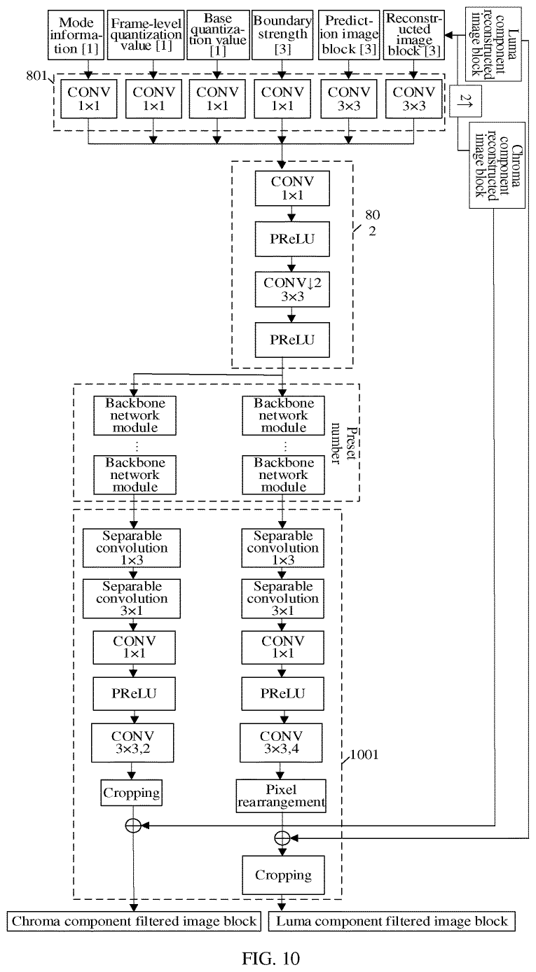

Exemplarily, based on FIG. 7, the output part may be as shown in part 901 in FIG. 9; based on FIG. 8, the output part may be as shown in part 1001 in FIG. 10. Through the output part, a chroma component filtered picture block and a luma component filtered picture block corresponding to the current block are determined, and the filtered picture block corresponding to the current block is determined in conjunction with the chroma component filtered picture block and the luma component filtered picture block.

In some embodiments, based on FIG. 9, a 3×3 convolution module and a PReLU activation function may also be connected between the output end of the preset number of backbone network modules and the input end of the output part. The specific selection may be made according to actual situations, which is not limited in the embodiments of the present disclosure.

In some embodiments, based on FIG. 9, a 3×3 convolution module and a PReLU activation function module may also be connected between the output end of the preset number of backbone network modules and the input end of the output part. The specific selection may be made according to actual situations, which is not limited in the embodiments of the present disclosure.

It can be understood that in the preset filtering network of the embodiments of the present disclosure, the feature channel number of the preprocessing part is a preset value, and the preset value is less than the feature channel number used for input data feature extraction in the HOP.2 and LOP.2 filters; and/or the number of backbone networks is a preset number, and the preset number is less than the number of backbone network layers in the HOP.2 and LOP.2 filters. In this way, by reducing the feature channel number of the preprocessing part and/or reducing the depth of the backbone network layers, the model complexity is effectively reduced, which is beneficial for applying the neural network-based loop filtering tool on more terminals, thereby improving the widespread application of the neural network-based filtering solution. Moreover, it has been verified through experiments that the preset filtering network of the embodiments of the present disclosure may still guarantee relatively high encoding and decoding performance at extremely low computation complexity (e.g., 5KMAC/pixel).

In some embodiments, the preset number of backbone networks include: a preset number of backbone network modules connected in series. Among the preset number of backbone network modules connected in series, each backbone network module includes: a first backbone network convolution module, a first separable convolution module, a third activation function, a second backbone network convolution module, and a second separable convolution module. The process of S102 may be implemented through the following process:
performing feature extraction on the initial feature or a feature output by a previous backbone network module, through the first backbone network convolution module and the first separable convolution module respectively, and performing feature merging and a non-linear operation on a feature extracted by the first backbone network convolution module and the first separable convolution module, through the third activation function, and performing convergence on a feature determined by the non-linear operation, through the second backbone network convolution module, and performing feature extraction on a converged feature through the second separable convolution module to determine the intermediate feature.

A feature channel number of at least one convolution module among the first backbone network convolution module, the first separable convolution module, the second backbone network convolution module, and the second separable convolution module is less than a feature channel number of a corresponding convolution module in the HOP.2 and LOP.2 filters.

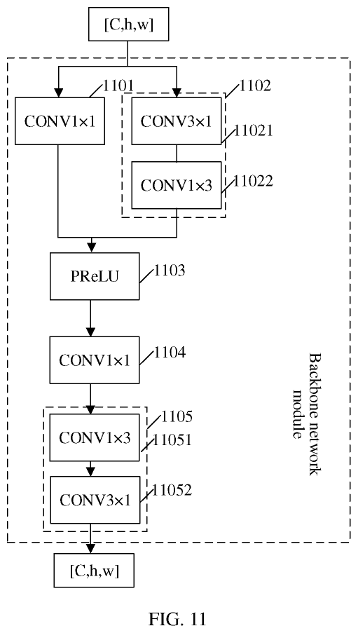

Exemplarily, based on FIG. 7 or FIG. 9, a network structure of the backbone network module may be as shown in FIG. 11, including: a first backbone network convolution module 1101, a first separable convolution module 1102, a third activation function module 1103, a second backbone network convolution module 1104, and a second separable convolution module 1105.

Herein, a feature channel number corresponding to the first backbone network convolution module 1101 is determined based on a preset first feature channel number; the first separable convolution module 1102 includes a first convolution kernel and a second convolution kernel; a feature channel number corresponding to the first convolution kernel 11021 is determined based on a preset second feature channel number; a feature channel number corresponding to the second convolution kernel 11022 is determined based on the preset second feature channel number and a preset third feature channel number; a feature channel number corresponding to the second backbone network convolution module 1104 is determined based on the preset first feature channel number and the preset third feature channel number; the second separable convolution module 1105 includes a third convolution kernel 11051 and a fourth convolution kernel 11052; a feature channel number corresponding to the third convolution kernel 11051 is determined based on a preset fourth feature channel number; a feature channel number corresponding to the fourth convolution kernel 11052 is determined based on the preset fourth feature channel number. In FIG. 11, [C, h, w] represents feature values of the input to or output feature corresponding to each backbone network module in three feature dimensions.

Herein, at least one of the preset first feature channel number, the preset second feature channel number, the preset third feature channel number, and the preset fourth feature channel number is less than a feature channel number of a corresponding convolution module in a backbone network module of the HOP.2 and LOP.2 filters.

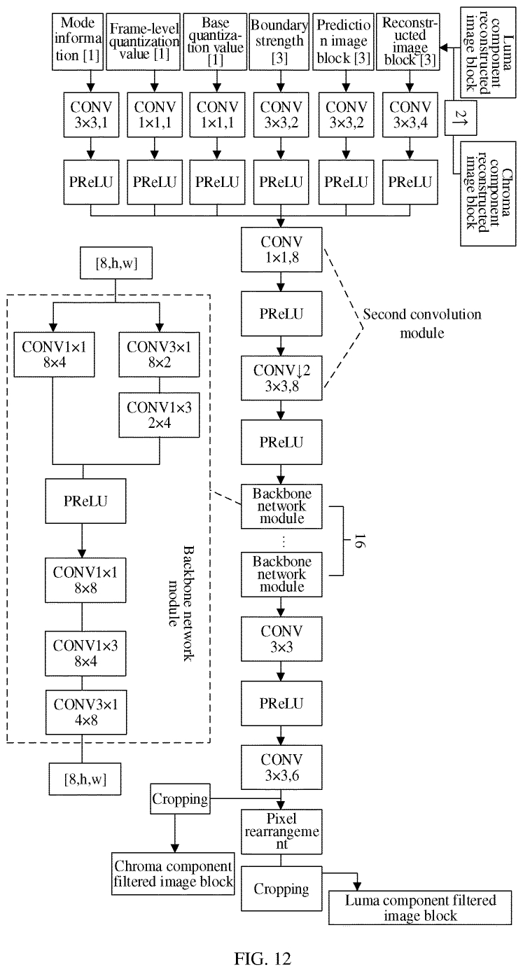

Exemplarily, as shown in FIG. 12, in the above preprocessing part, the preset feature channel number of the first convolution module corresponding to the reconstructed picture block, i.e., the first value, is 4; the preset feature channel number of the first convolution module corresponding to the prediction picture block, i.e., the second value, is 2; the preset feature channel number of the first convolution module corresponding to the boundary strength, i.e., the third value, is 2; the preset feature channel number of the first convolution module corresponding to the quantization parameter, i.e., the fourth value, is 1; and the preset feature channel number of the first convolution module corresponding to the mode information, i.e., the fifth value, is 1. The preset feature channel number of the second convolution module is 8; the preset filtering network includes 16 backbone network modules connected in series, and the network structure of each backbone network module among the 16 backbone network modules may be as shown in FIG. 11. In each backbone network module, the preset first feature channel number is 4; the preset second feature channel number is 2; the preset third feature channel number is 4; and the preset fourth feature channel number is 4.

As shown in FIG. 12, in each backbone network module, the feature channel number corresponding to the first backbone network convolution module is 8×4, where 8 represents the feature channel number C of the input feature (such as the initial feature or a feature output by a previous backbone network module) [C, h, w] corresponding to the backbone network module; and 4 is the preset first feature channel number corresponding to the first backbone network convolution module. The feature channel number corresponding to the first convolution kernel is 8×2; where 8 represents the feature channel number C of the input feature [C, h, w] corresponding to the backbone network module, and 2 is the preset second feature channel number corresponding to the first convolution kernel. The feature channel number corresponding to the second convolution kernel is 2×4, where 2 represents the preset second feature channel number corresponding to the second convolution kernel, and 4 represents the preset third feature channel number corresponding to the second convolution kernel. The feature channel number corresponding to the second backbone network convolution module is 8×8, where the first 8 represents a sum of the preset first feature channel number (4) and the preset third feature channel number (4), and the second 8 represents the feature channel number C of the input feature [C, h, w] corresponding to the backbone network module. The feature channel number corresponding to the third convolution kernel is 8×4; where 8 represents the feature channel number C of the input feature [C, h, w] corresponding to the backbone network module, and 4 represents the preset fourth feature channel number. The feature channel number corresponding to the fourth convolution kernel is 4×8; where 4 represents the preset fourth feature channel number, and 8 represents the feature channel number C of the input feature [C, h, w] corresponding to the backbone network module.

It can be understood that, based on the HOP.2 filter shown in FIG. 1, the embodiments of the present disclosure may reduce the complexity of the filtering network and improve the widespread application of the neural network-based filtering tool by reducing the feature channel numbers of convolution modules in the preprocessing part and/or convolution modules in the backbone network modules. Moreover, the values of the above first value, second value, third value, fourth value, fifth value, the preset feature channel number of the second convolution module, and the preset first feature channel number, the preset second feature channel number, the preset third feature channel number, and the preset fourth feature channel number have been verified through experiments to be able to maintain encoding and decoding compression performance on the basis of reducing complexity.

In some embodiments, based on FIG. 7 or FIG. 9, the preset number of backbone networks include: a preset number of backbone network modules connected in series. Among the preset number of backbone network modules connected in series, each backbone network module includes: a third separable convolution module, a fourth activation function module, and a fourth separable convolution module. The above S102 may be implemented through the following process:
performing feature extraction on the initial feature or a feature output by a previous backbone network module through the third separable convolution module, performing a non-linear operation on a feature extracted by the third separable convolution module through the fourth activation function, and performing feature extraction on a feature determined by the non-linear operation through the fourth separable convolution module to determine the intermediate feature.

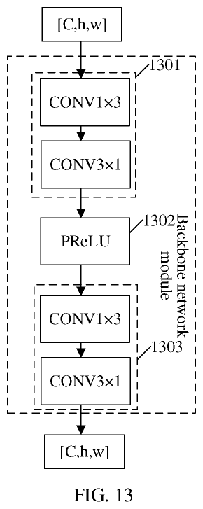

Exemplarily, based on FIG. 7 or FIG. 9, a network structure of the backbone network module may be as shown in FIG. 13, including: a third separable convolution module 1301, a fourth activation function module 1302, and a fourth separable convolution module 1303.

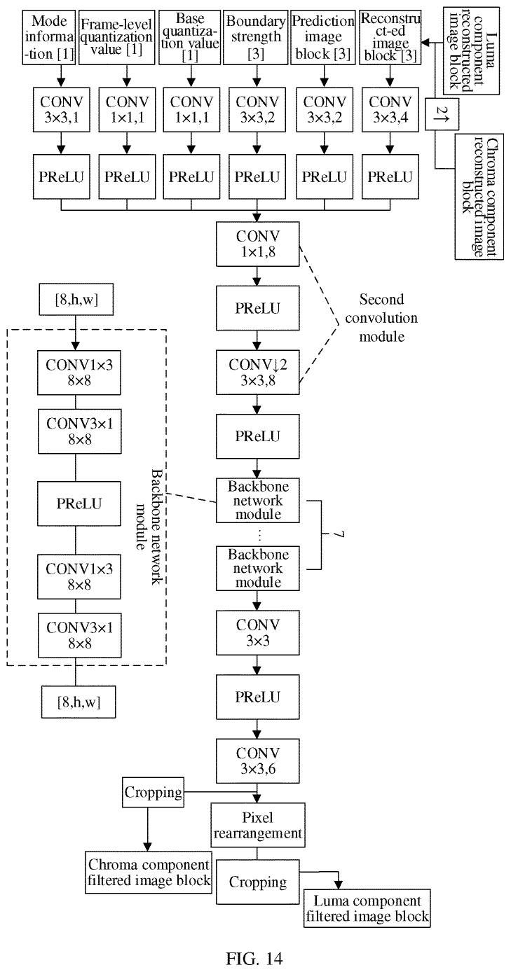

Exemplarily, as shown in FIG. 14, in the above preprocessing part, the preset feature channel number of the first convolution module corresponding to the reconstructed picture block, i.e., the first value, is 4; the preset feature channel number of the first convolution module corresponding to the prediction picture block, i.e., the second value, is 2; the preset feature channel number of the first convolution module corresponding to the boundary strength, i.e., the third value, is 2; the preset feature channel number of the first convolution module corresponding to the quantization parameter, i.e., the fourth value, is 1; the preset feature channel number of the first convolution module corresponding to the mode information, i.e., the fifth value, is 1; the preset feature channel number of the second convolution module is 8; the preset filtering network includes 7 backbone network modules connected in series; for each backbone network module among the 7 backbone network modules, the preset feature channel numbers of convolution kernels in the third separable convolution module and the fourth separable convolution module are determined based on the feature channel number of the initial feature and a sixth value, for example, the feature channel numbers of the convolution kernels in the third separable convolution module and the fourth separable convolution module are 8×8, where the feature channel number of the initial feature is 8, and the sixth value is 8.

It can be understood that, because in an extremely low complexity situation, the performance gain brought by a bifurcated path may not be as good as that of separable convolution. The embodiments of the present disclosure, based on the HOP.2 filter, remove the branch structure in the backbone network module and adopt backbone network modules with a single-branch structure (for example, composed of two pairs of 1×3 and 3×1 separable convolutions, and PReLU for a non-linear operation is used between the two convolution pairs, thereby ensuring the depth of the network model). In this way, the feature channel numbers of relevant convolution modules are reduced, thereby reducing the complexity of the filtering network and improving the widespread application of the neural network-based filtering tool. Moreover, the above first value, second value, third value, fourth value, fifth value, and the preset feature channel number of the second convolution module have been verified through experiments to be able to maintain encoding and decoding compression performance on the basis of reducing complexity.

In some embodiments, based on FIG. 8 or FIG. 10, the preset number of backbone networks include: a first preset number of first backbone network modules on a first network branch, and a second preset number of second backbone network modules on a second network branch; the intermediate feature includes: a luma intermediate feature and a chroma intermediate feature. The above S102 may be implemented through the following process:
performing luma feature extraction based on the initial feature through the first preset number of first backbone network modules, to determine an initial luma feature; performing feature extraction on the initial luma feature through a sixth separable convolution module on the first network branch, to determine the luma intermediate feature; performing chroma feature extraction on the initial feature through the second preset number of second backbone network modules, to determine an initial chroma feature; and performing feature extraction on the initial chroma feature through a seventh separable convolution module on the second network branch, to determine the chroma intermediate feature.

Herein, a feature channel number of at least one convolution module among the third backbone network convolution module, the fourth backbone network convolution module, the fifth separable convolution module, the sixth separable convolution module, and the seventh separable convolution module is less than a feature channel number of a corresponding convolution module in the HOP.2 and LOP.2 filters.

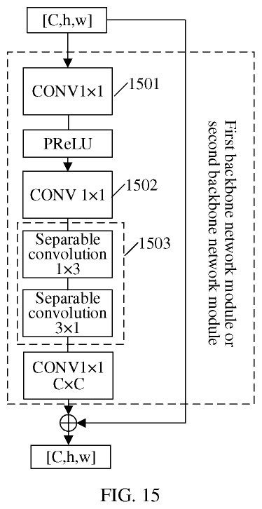

Herein, the first backbone network module includes: the third backbone network convolution module, the fourth backbone network convolution module, and the fifth separable convolution module; the second backbone network module includes: the third backbone network convolution module, the fourth backbone network convolution module, and the fifth separable convolution module; that is, the network structures of the first backbone network module and the second backbone network module are the same, and the feature channel numbers of the same backbone network convolution modules or separable convolution modules are also the same. Exemplarily, based on FIG. 8 or FIG. 10, the structure of the first backbone network module or the second backbone network module may be as shown in FIG. 15, including: a third backbone network convolution module 1501, a fourth backbone network convolution module 1502, and a fifth separable convolution module 1503. It can be seen that the first backbone network module or the second backbone network module may further include a 1×1 convolution module connected at the output end of the fifth separable convolution module 1503, and the feature channel number of this convolution module is determined by the feature channel number C of the feature input to the first backbone network module or the second backbone network module.

In some embodiments, the feature channel number corresponding to the third backbone network convolution module 1501 is determined based on a preset first feature channel number; the feature channel number corresponding to the fourth backbone network convolution module 1502 is determined based on the preset first feature channel number; the feature channel number corresponding to the fifth separable convolution module 1503 is determined based on a preset second feature channel number; the feature channel number corresponding to the sixth separable convolution module is determined based on a preset fifth feature channel number; and the feature channel number corresponding to the seventh separable convolution module is determined based on a preset sixth feature channel number. Herein, at least one of the preset first feature channel number, the preset second feature channel number, the preset fifth feature channel number, and the preset sixth feature channel number is less than a feature channel number of a corresponding convolution module in a backbone network module of the HOP.2 and LOP.2 filters.

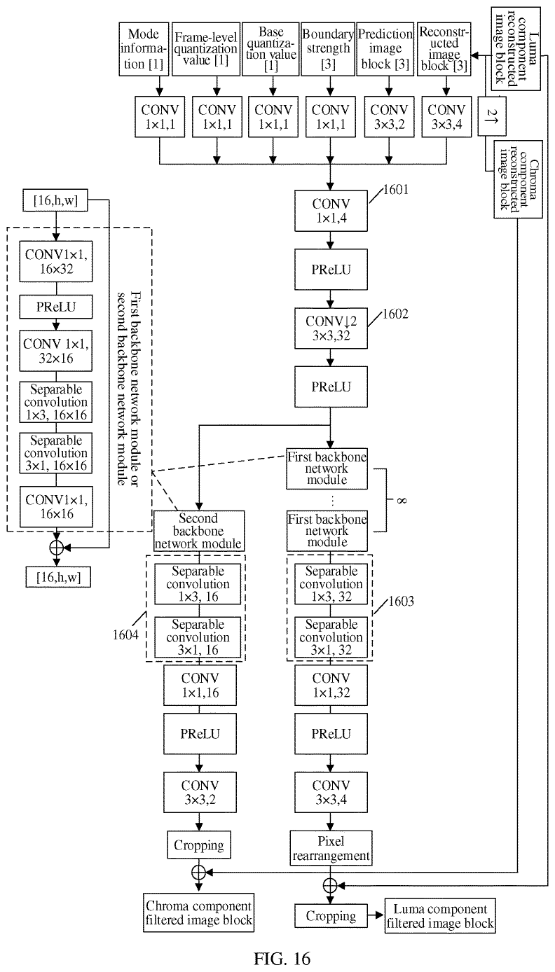

Exemplarily, as shown in FIG. 16, in the above preprocessing part, the preset feature channel number of the first convolution module corresponding to the reconstructed picture block, i.e., the first value, is 4; the preset feature channel number of the first convolution module corresponding to the prediction picture block, i.e., the second value, is 2; the preset feature channel number of the first convolution module corresponding to the boundary strength, i.e., the third value, is 1; the preset feature channel number of the first convolution module corresponding to the quantization parameter, i.e., the fourth value, is 1; and the preset feature channel number of the first convolution module corresponding to the mode information, i.e., the fifth value, is 1. The second convolution module includes a first merging convolution module 1601 and a first downsampling convolution module 1602; where a preset feature channel number corresponding to the first merging convolution module 1601 is 4; and a preset feature channel number corresponding to the first downsampling convolution module 1602 is 32. Herein, the preset feature channel number corresponding to the first downsampling convolution module 1602 includes 16 feature channels corresponding to the luma component and 16 feature channels corresponding to the chroma component; the preset number of backbone networks include: 8 first backbone network modules on the first network branch, and 1 second backbone network module on the second network branch. The first network branch is used to perform feature extraction based on the luma component of the 16 feature channels, and the first network branch is used to perform feature extraction based on the chroma component of the 16 feature channels.

For each first backbone network module or second backbone network module, the preset first feature channel number is 32; the preset second feature channel number is 16; the preset fifth feature channel number is 32; and the preset sixth feature channel number is 16.

As shown in FIG. 16, the feature channel number corresponding to the third backbone network convolution module is 16×32, where 16 represents the feature channel number C of the input feature (such as the initial feature or a feature output by a previous backbone network module) [C, h, w] corresponding to the backbone network module; and 32 is the preset first feature channel number corresponding to the third backbone network convolution module. The feature channel number corresponding to the fourth backbone network convolution module is 32×16, where 16 represents the feature channel number C of the input feature [C, h, w] of the backbone network module; and 32 is the preset first feature channel number corresponding to the fourth backbone network convolution module. The feature channel number corresponding to the fifth separable convolution module is 16×16; where one 16 represents the feature channel number C of the input feature [C, h, w] of the backbone network module, and the other 16 represents the preset second feature channel number. The feature channel number corresponding to the sixth separable convolution module 1603 is the preset fifth feature channel number, i.e., 32. The feature channel number corresponding to the seventh separable convolution module 1604 is the preset sixth feature channel number, i.e., 16.

It can be understood that, based on the LOP.2 filter shown in FIG. 2, the embodiments of the present disclosure may reduce the complexity of the filtering network and improve the widespread application of the neural network-based filtering tool by reducing the feature channel numbers of convolution modules in the preprocessing part and/or convolution modules in the backbone network modules. Moreover, the values of the above first value, second value, third value, fourth value, fifth value, the preset feature channel number of the second convolution module, and the preset first feature channel number, the preset second feature channel number, the preset fifth feature channel number, and the preset sixth feature channel number have been verified through experiments to be able to maintain encoding and decoding compression performance on the basis of reducing complexity.

In some embodiments, based on FIG. 8 or FIG. 10, the preset number of backbone networks include: a first preset number of first backbone network modules on a first network branch, and a second preset number of second backbone network modules on a second network branch; the intermediate feature includes: a luma intermediate feature and a chroma intermediate feature. The above S102 may be implemented through the following process:
performing luma feature extraction based on the initial feature through the first preset number of first backbone network modules, to determine an initial luma feature; where a first backbone network module includes an eighth separable convolution module; performing feature extraction on the initial luma feature through a sixth separable convolution module on the first network branch, to determine the luma intermediate feature; performing chroma feature extraction on the initial feature through the second preset number of second backbone network modules, to determine an initial chroma feature; where a second backbone network module includes a ninth separable convolution module; performing feature extraction on the initial chroma feature through a seventh separable convolution module on the second network branch, to determine the chroma intermediate feature.

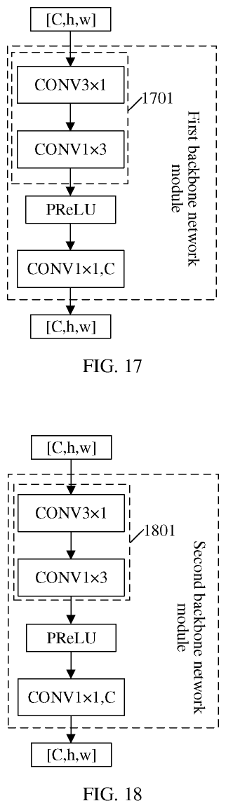

Exemplarily, based on FIG. 8 or FIG. 10, a network structure of the first backbone network module may be as shown in FIG. 17, including an eighth separable convolution module 1701. A network structure of the second backbone network module can be as shown in FIG. 18, including a ninth separable convolution module 1801. Herein, the module structures of the eighth separable convolution module and the ninth separable convolution module are the same, but their feature channel numbers are different. It can be seen that, in some embodiments, the output end of the eighth separable convolution module 1701 or the ninth separable convolution module 1801 may further be connected to a PReLU activation function module and a 1×1 convolution module, and the feature channel number of the 1×1 convolution module is determined by the feature channel number C of the feature input to the backbone network module.

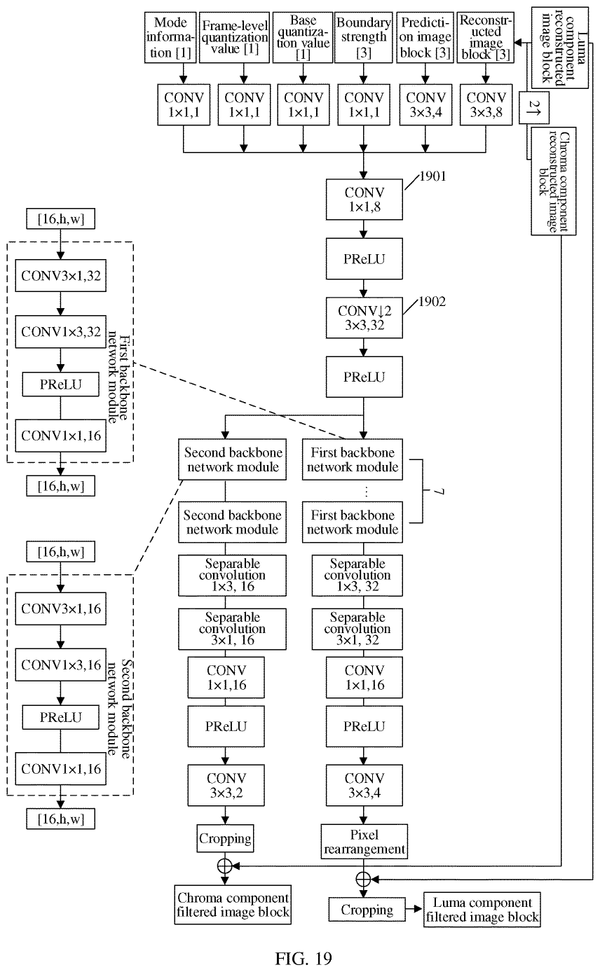

Exemplarily, as shown in FIG. 19, in the above preprocessing part, the preset feature channel number of the first convolution module corresponding to the reconstructed picture block, i.e., the first value, is 8; the preset feature channel number of the first convolution module corresponding to the prediction picture block, i.e., the second value, is 4; the preset feature channel number of the first convolution module corresponding to the boundary strength, i.e., the third value, is 1; the preset feature channel number of the first convolution module corresponding to the quantization parameter, i.e., the fourth value, is 1; and the preset feature channel number of the first convolution module corresponding to the mode information, i.e., the fifth value, is 1. The second convolution module includes a merging convolution module 1901 and a downsampling convolution module 1902; where a preset feature channel number corresponding to the second merging convolution module 1901 is 8; and a preset feature channel number corresponding to the second downsampling convolution module 1902 is 32. Herein, the preset feature channel number corresponding to the second downsampling convolution module 1902 includes 16 feature channels corresponding to the luma component and 16 feature channels corresponding to the chroma component. The first network branch includes 7 first backbone network modules, and the second network branch includes 2 second backbone network modules. The first network branch is used to perform feature extraction based on the luma component of the 16 feature channels, and the second network branch is used to perform feature extraction based on the chroma component of the 16 feature channels.

For each first backbone network module, the feature channel number corresponding to the eighth separable convolution module is determined based on the feature channel number of the initial feature. For each second backbone network module, the feature channel number corresponding to the ninth separable convolution module is less than the feature channel number corresponding to the eighth separable convolution module. Exemplarily, as shown in FIG. 19, the feature channel number corresponding to the eighth separable convolution module is 32; and the feature channel number corresponding to the ninth separable convolution module is 16.

It can be understood that, based on the LOP.2 filter shown in FIG. 2, backbone network modules with different feature channel numbers are applied to the chroma component path and the luma component path. Herein, the main compositions of the backbone network modules of the chroma component path and the luma component path are the same, consisting of a pair of 1×3 and 3×1 separable convolutions followed by PReLU for a non-linear operation, and finally a 1×1 convolution is used to converge the feature; but the feature channel numbers of the backbone network modules on the chroma component path and the luma component path are different. In this way, for the luma component path with richer feature information, more feature paths are used for feature extraction, which can guarantee compression performance; and for the chroma component path with less feature information, fewer feature paths are used for feature extraction, which can reduce the complexity of the filtering network. In this way, on the basis of guaranteeing encoding compression performance, the complexity of the filtering network is reduced, and the widespread application of the neural network-based filtering tool is improved. Moreover, the above first value, second value, third value, fourth value, fifth value, the preset feature channel number of the second convolution module, and the preset feature channel numbers corresponding to the eighth separable convolution module and the ninth separable convolution module have been verified through experiments to be able to maintain encoding and decoding compression performance on the basis of reducing complexity.

In some embodiments, in the case of determining the filtered picture block corresponding to the current block in S103, the encoder may further determine a filtered picture corresponding to a current picture based on the filtered picture block corresponding to the current block; and implement inter prediction decoding by using the filtered picture corresponding to the current picture.

In some embodiments, the above-mentioned separable convolution module may also be replaced by a transformer network model.

Exemplarily, the encoder obtains the reconstructed picture block after prediction, transform, quantization, and inverse quantization and inverse transform, and starts to perform loop filtering, to improve picture quality. Based on an enable flag of neural network loop filtering, sps_nnlf_enable_flag, if the enable flag is true, the neural network-based loop filtering tool is enabled for use; otherwise, the neural network-based loop filtering tool is not enabled for use.

Step 1: if the enable flag of the neural network-based loop filtering tool is true, step 2 is performed; otherwise, step 2 is skipped and step 3 is directly performed.

Step 2: the above preset filtering network is loaded and initialized according to a preset parameter, where a parameter such as convolution in the preset filtering network has been obtained through training and integer-quantized. A reconstructed sample rec, a prediction sample pred, boundary strength BS, mode information IPB, quantization information BaseQP and SliceQP of the current coding tree unit region are acquired, and these information are input into the preset filtering network for inference calculation; an initial filtered picture block filteredRec is obtained after the preset filtering network.

If a residual scaling technology is used for the current frame or the current coding tree unit, a residual scaling parameter is calculated according to the current block (i.e., an original picture block), the reconstructed picture block, and the filtered picture block. The encoder calculates a rate-distortion cost between the obtained parameter and a default parameter, and selects an optimal parameter. This parameter is dot-multiplied by the residual between the initial filtered picture block filteredRec and the reconstructed picture block rec, and then the scaled residual is added back to the reconstructed picture block rec to obtain a filtered picture block output. If the residual scaling technology is not used for the current frame or the current coding tree unit, the initial filtered picture block filteredRec is the filtered picture block output.

After the filtering is finished, if the neural network-based loop filtering is used for all coding tree units of the current picture, the encoder sets a picture-level flag sh_nnlf_flag to a first flag value and writes it into the bitstream. If the neural network-based loop filtering is used for a part of coding tree units in the current picture, the picture-level flag sh_nnlf_flag is set to a second flag value, a ctb_nnlf_flag for the coding tree units using the neural network loop filtering technology is set to true, a ctb_nnlf flag for the coding tree units not using the technology is set to false, and finally sh_nnlf_flag and all ctb_nnlf flags are written into the bitstream together. If the neural network-based loop filtering technology is not used for all coding tree units of the current picture, the picture-level flag sh_nnlf_flag is set to a third flag value and written into the bitstream.

For sh_nnlf_flag being the first flag value or the second flag value, it is necessary to check the usage of the residual scaling technology; if the current frame uses the residual scaling technology, the picture-level flag scaleFlag is set to true and written into the bitstream together with a corresponding residual scaling index scaleIdx; if the current picture does not use the residual scaling technology, the picture-level flag scaleFlag is set to false and written into the bitstream.

Step 3: the encoder continues to operate other loop filtering technologies.

Step 4: after performing all loop filtering tools, a final output picture is obtained, and bitstream information is output.

In some embodiments, the above intermediate feature includes: at least two intermediate features, the at least two intermediate features correspond to at least two initial features; the at least two initial features are determined by performing feature extraction based on the reconstructed picture block through the preprocessing part, in combination with at least two candidate base quantization parameters corresponding to the current block, respectively; the at least two candidate base quantization parameters are determined by a base quantization parameter corresponding to the current block and at least two candidate quantization offsets; the above process of determining the filtered picture block corresponding to the current block according to the intermediate feature through the output part in the preset filtering network may include:
determining at least two candidate filtered picture blocks corresponding to the current block according to the at least two intermediate features, through the output part in the preset filtering network; determining at least two first distortion costs corresponding to the at least two candidate filtered picture blocks; and determining the filtered picture block corresponding to the current block according to the at least two first distortion costs.

In some embodiments, a target quantization offset among the at least two candidate quantization offsets is determined according to the at least two first distortion costs, and first syntax identification information corresponding to the target quantization offset is determined; entropy encoding is performed on the first syntax identification information, and obtained encoded bits are written into the bitstream.

That is, the neural network-based loop filtering model uses a wider range of quantization parameters as the input during the training process, so the model has good generalization ability; when filtering at the encoder side, different quantization values may be selected as the input. For example, a base quantization parameter BaseQP of the current frame is acquired, an allowed offset Qpoffset {−10, −5, 5, 10} is selected at the encoder side, different filtered pictures are acquired, a distortion cost of each filtered picture is calculated, and an optimal quantization parameter is selected as the input. And the offset index Qpoffset Index is written into the bitstream and transmitted to the decoder, and the decoder adds the corresponding Qpoffset and BaseQP as a network model input according to the offset index obtained by parsing, and filters the decoded reconstructed picture.

In some embodiments, the intermediate feature includes: at least two intermediate features; the at least two intermediate features correspond to at least two types of reconstructed picture blocks; the at least two types of reconstructed picture blocks are determined by performing transposition processing on the reconstructed picture block through at least two preset transposition angles.

Determining the filtered picture block corresponding to the current block according to the intermediate feature through the output part in the preset filtering network, includes:
determining at least two candidate filtered picture blocks corresponding to the current block according to the at least two intermediate features, through the output part in the preset filtering network;
determining at least two second distortion costs corresponding to the at least two candidate filtered picture blocks;
determining the filtered picture block corresponding to the current block according to the at least two second distortion costs.

In some embodiments, a target transposition angle among the at least two preset transposition angles is determined according to the at least two second distortion costs, and second syntax identification information corresponding to the target transposition angle is determined; and
entropy encoding is performed on the second syntax identification information, and obtained encoded bits are written into a bitstream.

In some embodiments, network training is performed on an initial filtering network by a reconstructed sample picture block set including reconstructed sample picture blocks with the at least two preset transposition angles, to determine the preset filtering network.

That is, the encoder may try to perform horizontal flipping, vertical flipping, forward 90-degree rotation, backward 90-degree rotation, 45-degree transposition, and 135-degree transposition, etc., on the current block. Filtered picture blocks under different situations are obtained, rate-distortion cost optimization is performed for different transposition angles, an optimal manner is selected, and a corresponding index GeoTransformIndex is written into the bitstream and transmitted to the decoder; the decoder performs corresponding transformation on the input and output according to the geometric transformation index GeoTransformIndex obtained by parsing, to obtain the filtered reconstructed picture.

In some embodiments, the intermediate feature includes: a first intermediate feature and a second intermediate feature; the first intermediate feature corresponds to a first reconstructed picture block; the second intermediate feature corresponds to a second reconstructed picture block; the first reconstructed picture block includes an original reconstructed picture block corresponding to the current block; the second reconstructed picture block includes an initial filtered picture block determined by performing Gaussian filtering on the original reconstructed picture block.

Determining the filtered picture block corresponding to the current block according to the intermediate feature through the output part in the preset filtering network, includes:
determining a first candidate filtered picture block corresponding to the current block according to the first intermediate feature through the output part in the preset filtering network; and determining a second candidate filtered picture block corresponding to the current block according to the second intermediate feature;
determining a third distortion cost corresponding to the first candidate filtered picture block, and a fourth distortion cost corresponding to the second candidate filtered picture block; and
determining the filtered picture block corresponding to the current block according to the third distortion cost and the fourth distortion cost.

In some embodiments, third syntax identification information is determined according to the third distortion cost and the fourth distortion cost; where the third syntax identification information indicates whether to perform Gaussian filtering on the current block; entropy encoding is performed on the third syntax identification information, and writing obtained encoded bits into a bitstream.

That is, the current neural network-based loop filtering technology all use a reconstructed picture without loop filtering as the input, but the reconstructed picture has a lot of noise. It is possible to first filter the reconstructed picture by using Gaussian filtering and then use it as the input of the network model, and after the inference of the network model, a new filtered picture is obtained, and a rate-distortion cost in this case is calculated and compared with the case where the reconstructed picture without Gaussian filtering as the input. If the cost of the Gaussian filtering is smaller, a Gaussian filtering flag is set to true and written into the bitstream; otherwise, the Gaussian filtering flag is set to false and written into the bitstream.

In some embodiments, the encoder may perform network training on an initial filtering network by using at least two reconstructed sample picture sets to determine the preset filtering network; the at least two reconstructed sample picture sets include at least two of a reconstructed sample picture set without loop filtering, a reconstructed sample picture set with deblocking filtering, a reconstructed sample picture set with sample adaptive offset filtering, and a reconstructed sample picture set with adaptive loop filtering.

In some embodiments, the above process of performing network training on the initial filtering network by using the at least two reconstructed sample picture sets, to determine the preset filtering network includes: performing network training on the initial filtering network by using the at least two reconstructed sample picture sets, to determine at least two candidate filtering networks. Further, the encoder may perform filtering based on the reconstructed picture block through the at least two candidate filtering networks, to determine at least two candidate filtered picture blocks corresponding to the at least two candidate filtering networks; determine at least two fourth distortion costs corresponding to the at least two candidate filtered pictures; determine a filtered picture block corresponding to the current block according to the at least two fourth distortion costs, and/or determine a preset filtering network corresponding to a current picture.

That is, multiple models may be trained according to different data sets, and it is decided at the encoder side which model has a better filtering effect for the current frame or the current coding tree unit.

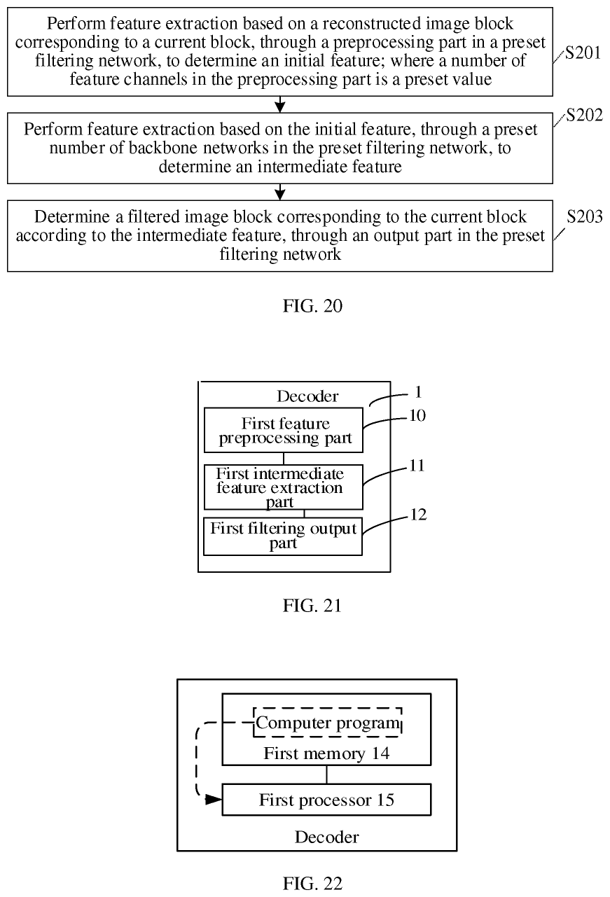

In an embodiment of the present disclosure, referring to FIG. 20, a schematic flowchart of a decoding method provided in the embodiments of the present disclosure is shown. The method may include S201 to S203.

In S201: perform feature extraction based on a reconstructed picture block corresponding to a current block through a preprocessing part in a preset filtering network, to determine an initial feature; where a feature channel number of the preprocessing part is a preset value.

In some embodiments, the current block may be a current coding unit (CU), a current transform unit (TU), a current prediction unit (PU), a current coding block (CB), etc., which are not specifically limited in the embodiments of the present disclosure.

In S201, the feature channel number of the preprocessing part is a preset value.

Herein, the feature channel number of the preprocessing part, i.e., the preset value, is less than a feature channel number used for input data feature extraction in HOP.2 and LOP.2 filters; and/or the preset number is less than a number of backbone network layers in the HOP.2 and LOP.2 filters.

In S202: perform feature extraction based on the initial feature through a preset number of backbone networks in the preset filtering network, to determine an intermediate feature.

In S203: determine a filtered picture block corresponding to the current block according to the intermediate feature through an output part in the preset filtering network.

The processes in S201 to S203 are consistent with the descriptions of the processes in S101 to S103 in the encoder, which are not repeated here.

In some embodiments, the preprocessing part includes at least one group of first convolution parts, and a second convolution part, the at least one group of first convolution parts corresponds to at least one type of input data; the at least one type of input data at least includes the reconstructed picture block; the first convolution part includes a first convolution module; the second convolution part includes at least one group of second convolution modules and a second activation function module; the preset value includes: a preset feature channel number of at least one first convolution module and/or a preset feature channel number of the second convolution module; performing feature extraction based on the reconstructed picture block corresponding to the current block through the preprocessing part in the preset filtering network, to determine the initial feature, includes:
performing feature extraction on the at least one type of input data through the at least one group of first convolution parts, to determine at least one input feature; and
merging the at least one input feature through the second convolution part, and performing at least one feature extraction based on a merged input feature to determine the initial feature; where the preset feature channel number of the first convolution module is less than a feature channel number of the first convolution module in the HOP.2 and LOP.2 filters; and/or the preset feature channel number of the second convolution module is less than a feature channel number of a corresponding convolution module in the HOP.2 and LOP.2 filters.

In some embodiments, the preset number of backbone networks include: a preset number of backbone network modules connected in series; the backbone network module includes: a first backbone network convolution module, a first separable convolution module, a third activation function module, a second backbone network convolution module, and a second separable convolution module; performing feature extraction based on the initial feature through the preset number of backbone networks in the preset filtering network, to determine the intermediate feature, includes:
performing feature extraction on the initial feature or a feature output by a previous backbone network module, through the first backbone network convolution module and the first separable convolution module respectively, and performing feature merging and a non-linear operation on a feature extracted by the first backbone network convolution module and the first separable convolution module, through the third activation function module, and performing convergence on a feature determined by the non-linear operation, through the second backbone network convolution module, and performing feature extraction on a converged feature through the second separable convolution module to determine the intermediate feature; where a feature channel number of at least one convolution module among the first backbone network convolution module, the first separable convolution module, the second backbone network convolution module, and the second separable convolution module is less than a feature channel number of a corresponding convolution module in the HOP.2 and LOP.2 filters.

In some embodiments, the at least one type of input data includes at least one of a reconstructed picture block, a prediction picture block, boundary strength, a quantization parameter, or mode information; a preset feature channel number of a first convolution module corresponding to the reconstructed picture block is a first value; the first value is less than a feature channel number of a convolution module used for performing feature extraction on the reconstructed picture block in the HOP.2 and LOP.2 filters; and/or a preset feature channel number of a first convolution module corresponding to the prediction picture block is a second value; the second value is less than a feature channel number of a convolution module used for performing feature extraction on the prediction picture block in the HOP.2 and LOP.2 filters; and/or a preset feature channel number of a first convolution module corresponding to the boundary strength is a third value; the third value is less than a feature channel number of a convolution module used for performing feature extraction on the boundary strength in the HOP.2 and LOP.2 filters; and/or a preset feature channel number of a first convolution module corresponding to the quantization parameter is a fourth value; the fourth value is less than a feature channel number of a convolution module used for performing feature extraction on the quantization parameter in the HOP.2 and LOP.2 filters; and/or a preset feature channel number of a first convolution module corresponding to the mode information is a fifth value; the fifth value is less than a feature channel number of a convolution module used for performing feature extraction on the mode information in the HOP.2 and LOP.2 filters.

In some embodiments, a feature channel number corresponding to the first backbone network convolution module is determined based on a preset first feature channel number; the first separable convolution module includes a first convolution kernel and a second convolution kernel; a feature channel number corresponding to the first convolution kernel is determined based on a preset second feature channel number; a feature channel number corresponding to the second convolution kernel is determined based on the preset second feature channel number and a preset third feature channel number; a feature channel number corresponding to the second backbone network convolution module is determined based on the preset first feature channel number and the preset third feature channel number; the second separable convolution module includes a third convolution kernel and a fourth convolution kernel; a feature channel number corresponding to the third convolution kernel is determined based on a preset fourth feature channel number; a feature channel number corresponding to the fourth convolution kernel is determined based on the preset fourth feature channel number;
at least one among the preset first feature channel number, the preset second feature channel number, the preset third feature channel number, and the preset fourth feature channel number is less than a feature channel number of a corresponding convolution module in the backbone network module of the HOP.2 and LOP.2 filters.

In some embodiments, the first value is 4; the second value is 2; the third value is 2; the fourth value is 1; the fifth value is 1; the preset feature channel number of the second convolution module is 8; the preset filtering network includes 16 backbone network modules connected in series, and for each backbone network module among the 16 backbone network modules, the preset first feature channel number is 4; the preset second feature channel number is 2; the preset third feature channel number is 4; and the preset fourth feature channel number is 4.

In some embodiments, the preset number of backbone networks include: a preset number of backbone network modules connected in series; the backbone network module includes: a third separable convolution module, a fourth activation function module, and a fourth separable convolution module; performing feature extraction based on the initial feature through the preset number of backbone networks in the preset filtering network, to determine the intermediate feature, includes:
performing feature extraction on the initial feature or a feature output by a previous backbone network module through the third separable convolution module, performing non-linear operation on a feature extracted by the third separable convolution module through the fourth activation function module, and performing feature extraction on a feature determined by the non-linear operation through the fourth separable convolution module to determine the intermediate feature.

In some embodiments, the first value is 4; the second value is 2; the third value is 2; the fourth value is 1; the fifth value is 1; the preset feature channel number of the second convolution module is 8; the preset filtering network includes 7 backbone network modules connected in series, and for each backbone network module among the 7 backbone network modules, preset feature channel numbers of convolution kernels in the third separable convolution module and the fourth separable convolution module are determined based on a sixth value.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; performing feature extraction based on the initial feature through the preset number of backbone networks in the preset filtering network, to determine the intermediate feature, includes:
performing luma feature extraction based on the initial feature through the first preset number of first backbone network modules, to determine an initial luma feature; where the first backbone network module includes a third backbone network convolution module, a fourth backbone network convolution module, and a fifth separable convolution module; performing feature extraction on the initial luma feature through a sixth separable convolution module on the first network branch, to determine the luma intermediate feature; performing chroma feature extraction on the initial feature through the second preset number of second backbone network modules, to determine an initial chroma feature; where the second backbone network module includes: the third backbone network convolution module, the fourth backbone network convolution module, and the fifth separable convolution module; and performing feature extraction on the initial chroma feature through a seventh separable convolution module on the second network branch, to determine the chroma intermediate feature; where a feature channel number of at least one convolution module among the third backbone network convolution module, the fourth backbone network convolution module, the fifth separable convolution module, the sixth separable convolution module, and the seventh separable convolution module is less than a feature channel number of a corresponding convolution module in the HOP.2 and LOP.2 filters.

In some embodiments, a feature channel number corresponding to the third backbone network convolution module is determined based on a preset first feature channel number;
a feature channel number corresponding to the fourth backbone network convolution module is determined based on the preset first feature channel number; a feature channel number corresponding to the fifth separable convolution module is determined based on a preset second feature channel number; a feature channel number corresponding to the sixth separable convolution module is determined based on a preset fifth feature channel number; a feature channel number corresponding to the seventh separable convolution module is determined based on a preset sixth feature channel number; at least one of the preset first feature channel number, the preset second feature channel number, the preset fifth feature channel number, and the preset sixth feature channel number is less than a feature channel number of a corresponding convolution module in a backbone network module of the HOP.2 and LOP.2 filters.

In some embodiments, the first value is 4; the second value is 2; the third value is 1; the fourth value is 1; the fifth value is 1; the second convolution module includes a first merging convolution module and a first downsampling convolution module; a preset feature channel number corresponding to the first merging convolution module is 4; a preset feature channel number corresponding to the first downsampling convolution module is 32; the preset number of backbone networks include: 8 first backbone network modules on a first network branch, and 1 second backbone network module on a second network branch; for the first backbone network module or the second backbone network module, the preset first feature channel number is 32; the preset second feature channel number is 16; the preset fifth feature channel number is 32; and the preset sixth feature channel number is 16.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; performing feature extraction based on the initial feature through the preset number of backbone networks in the preset filtering network, to determine the intermediate feature, includes:
performing luma feature extraction based on the initial feature through the first preset number of first backbone network modules, to determine an initial luma feature; where the first backbone network module includes an eighth separable convolution module; performing feature extraction on the initial luma feature through a sixth separable convolution module on the first network branch, to determine the luma intermediate feature; performing chroma feature extraction on the initial feature through the second preset number of second backbone network modules, to determine an initial chroma feature; where the second backbone network module includes a ninth separable convolution module; performing feature extraction on the initial chroma feature through a seventh separable convolution module on the second network branch, to determine the chroma intermediate feature.

In some embodiments, the first value is 8; the second value is 4; the third value is 1; the fourth value is 1; the fifth value is 1; the second convolution module includes a second merging convolution module and a second downsampling convolution module; a preset feature channel number corresponding to the second merging convolution module is 8; a preset feature channel number corresponding to the second downsampling convolution module is 32; the first network branch includes 7 first backbone network modules, and the second network branch includes 2 second backbone network modules; a feature channel number corresponding to the eighth separable convolution module is 32; and a feature channel number corresponding to the ninth separable convolution module is 16.

In some embodiments, a filtered picture corresponding to a current picture is determined based on the filtered picture block corresponding to the current block; and inter prediction decoding is implemented by using the filtered picture corresponding to the current picture.

In some embodiments, the decoding method further includes:
parsing a bitstream to determine first syntax identification information; determining a target quantization offset from at least two candidate base quantization parameters according to the first syntax identification information; updating a quantization parameter corresponding to the current block by using the target quantization offset, to perform filtering based on the reconstructed picture block and an updated quantization parameter through the preset filtering network to determine the filtered picture block.

In some embodiments, the method further includes:
parsing a bitstream to determine second syntax identification information; determining a target transposition angle from at least two preset transposition angles according to the second syntax identification information; performing transposition processing on the reconstructed picture block according to the target transposition angle, to perform filtering based on a transposed reconstructed picture block through the preset filtering network to determine the filtered picture block.

In some embodiments, the decoding method further includes:
parsing a bitstream to determine third syntax identification information; in response to the third syntax identification information indicating to perform Gaussian filtering on the reconstructed picture block, determining an initial filtered picture block by performing Gaussian filtering on the reconstructed picture block, and performing filtering based on the initial filtered picture block through the preset filtering network, to determine the filtered picture block.

In some embodiments, the decoding method further includes:
performing network training on an initial filtering network by using at least two reconstructed sample picture sets, to determine the preset filtering network;
the at least two reconstructed sample picture sets include:
at least two of a reconstructed sample picture set without loop filtering, a reconstructed sample picture set with deblocking filtering, a reconstructed sample picture set with sample adaptive offset filtering, and a reconstructed sample picture set with adaptive loop filtering.

In some embodiments, performing network training on the initial filtering network by using the at least two reconstructed sample picture sets, to determine the preset filtering network, includes:
performing network training on the initial filtering network by using the at least two reconstructed sample picture sets, to determine at least two candidate filtering networks; the decoding method further includes:
performing filtering based on the reconstructed picture block through the at least two candidate filtering networks, to determine at least two candidate filtered picture blocks corresponding to the at least two candidate filtering networks; determining at least two fourth distortion costs corresponding to the at least two candidate filtered pictures; determining a filtered picture block corresponding to the current block according to the at least two fourth distortion costs, and/or determining a preset filtering network corresponding to a current picture.

Exemplarily, corresponding to the above embodiments of the encoder, the decoder parses or acquires an enable flag for neural network-based loop filtering, the flag is a sequence-level flag (sps_nnlf_enable_flag), indicating that the current decoder is enabled to use the neural network-based loop filtering technology. If sps_nnlf_enable_flag is true, execution starts from Step 1; otherwise, execution starts from Step 3.

Step 1: the bitstream is parsed to obtain a frame-level usage flag sh_nnlf_flag of the neural network-based loop filtering technology.

If sh_nnlf_flag indicates that the neural network-based loop filtering technology is used for all coding tree units of the current frame, ctb_nnlf_flag of all coding tree units of the current frame are set to true.

If sn_nnlf_flag indicates that the neural network-based loop filtering technology is used for a part of coding tree units of the current frame, the decoder parses a ctb_nnlf_flag flag of each coding tree unit.

If sh_nnlf_flag indicates that the neural network-based loop filtering technology is not used for all coding tree units of the current frame, ctb_nnlf_flag of all coding tree units of the current frame are set to false.

If it is sh_case1 or sh_case2, it parses a residual scaling flag scaleFlag of the current frame; otherwise, scaleFlag defaults to false.

If scaleFlag is true, it further parses a residual scaling parameter index scaleIdx; if the parsed scaleIdx indicates that it is necessary to further parse the bitstream to acquire the residual scaling parameter, it parses the bitstream to acquire the residual scaling parameter scale of the color component of the current frame; otherwise, it obtains a preset residual scaling parameter scale according to the index.

Step 2: the preset filtering network is loaded and initialized according to a preset parameter, where a parameter such as convolution in the preset filtering network has been obtained through training and integer-quantized.

If a neural network-based loop filtering usage flag ctb_nnlf_flag of the current coding tree unit is true, a reconstructed picture block rec, a prediction picture block pred, boundary strength BS, mode information IPB, quantization information BaseQP and SliceQP, and an edge picture of the current coding tree unit region are acquired, and these information is input into the preset filtering network for inference calculation; an initial filtered picture block filteredRec is obtained after the inference of the preset filtering network; if scaleFlag is true, a residual scaling factor scale for each color component is acquired according to the parsed residual scaling parameter index scaleIdx. The scale is dot-multiplied by the residual between the initial filtered picture block filteredRec and the reconstructed picture block rec, and then the scaled residual back is added to the initial filtered picture block rec to obtain a filtered picture block output. If the residual scaling technology is not used for the current picture or the current coding tree unit, the initial filtered picture block filteredRec is the filtered picture block output.

If the neural network-based loop filtering usage flag ctb_nnlf_flag of the current coding tree unit is false, the reconstructed picture block rec is the filtered picture block output.

Step 3, the decoder continues to operate other loop filtering technologies.

Step 4, after performing all loop filtering tools, a final output picture is obtained.

It should be noted that the encoder and the decoder should use the preset filtering networks with the same network structure.

In some embodiments, based on the above video encoding and decoding methods provided in the embodiments of the present disclosure, the preset filtering network provided in the embodiments of the present disclosure is used to implement the filtering unit in the codec, and testing is performed under common test conditions. Test results are shown in Table 1 and Table 2. Herein, Table 1 is the test result based on the preset filtering network of FIG. 12, and Table 2 is the test result based on the preset filtering network of FIG. 16.

TABLE 1
All Intra Main10

| | BD-rate Over VTM-11.0 | | | | |
|---|---|---|---|---|---|
| | Y-PSNR | U-PSNR | V-PSNR | EncT | DecT CPU |
| Class A1 | −2.20% | −0.30% | 0.61% | 108% | 3403% |
| Class A2 | −2.41% | −0.33% | −0.46% | 103% | 3014% |
| Class B | −2.27% | −0.18% | −0.12% | 102% | 2766% |
| Class C | −2.03% | −0.43% | −0.41% | 100% | 2030% |
| Class E | −3.09% | 0.36% | 0.77% | 102% | 2906% |
| Overall | −2.36% | −0.19% | 0.03% | 103% | 2734% |
| Class D | −2.05% | −0.33% | −0.29% | 98% | 1733% |
| Class F | −1.42% | −0.59% | −0.96% | 100% | 2122% |

TABLE 2
All Intra Main10

| | BD-rate Over VTM-11.0 | | | | |
|---|---|---|---|---|---|
| | Y-PSNR | U-PSNR | V-PSNR | EncT | DecT CPU |
| Class A1 | −2.90% | −2.81% | −2.58% | 79% | 1895% |
| Class A2 | −3.24% | −4.10% | −2.65% | 75% | 1540% |
| Class B | −3.13% | −4.70% | −3.81% | 80% | 1549% |
| Class C | −3.16% | −5.31% | −4.03% | 83% | 1362% |
| Class E | −4.38% | −3.35% | −3.55% | 90% | 2062% |
| Overall | −3.32% | −4.19% | −3.42% | 81% | 1631% |
| Class D | −3.46% | −4.88% | −3.47% | 86% | 980% |
| Class F | −2.20% | −4.32% | −3.30% | 77% | 1179% |

In Table 1 and Table 2, negative values represent performance gains, i.e., a bitrate saving ratio at the same quality. It can be seen that the preset filtering network of the embodiments of the present disclosure may still guarantee relatively high encoding and decoding compression performance on the basis of reducing network complexity.

Based on the implementation basis of the foregoing embodiments, as shown in FIG. 21, the embodiments of the present disclosure provide a decoder 1, including:
a first feature preprocessing part 10, configured to perform feature extraction based on a reconstructed picture block corresponding to a current block through a preprocessing part in a preset filtering network, to determine an initial feature; where a feature channel number of the preprocessing part is a preset value;
a first intermediate feature extraction part 11, configured to perform feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters; and
a first filtering output part 12, configured to determine a filtered picture block corresponding to the current block according to the intermediate feature through an output part in the preset filtering network.

In some embodiments, the preprocessing part includes at least one group of first convolution parts, and a second convolution part, the at least one group of first convolution parts corresponds to at least one type of input data; the at least one type of input data at least includes the reconstructed picture block; the first convolution part includes a first convolution module; the second convolution part includes at least one group of second convolution modules and a second activation function module; the preset value includes: a preset feature channel number of at least one first convolution module and/or a preset feature channel number of the second convolution module; the first feature preprocessing part 10 is further configured to: perform feature extraction on the at least one type of input data through the at least one group of first convolution parts, to determine at least one input feature; and merge the at least one input feature through the second convolution part, and perform at least one feature extraction based on a merged input feature to determine the initial feature; where the preset feature channel number of the first convolution module is less than a feature channel number of the first convolution module in the HOP.2 and LOP.2 filters; and/or the preset feature channel number of the second convolution module is less than a feature channel number of a corresponding convolution module in the HOP.2 and LOP.2 filters.

In some embodiments, the preset number of backbone networks include: a preset number of backbone network modules connected in series; the backbone network module includes: a first backbone network convolution module, a first separable convolution module, a third activation function module, a second backbone network convolution module, and a second separable convolution module; the first intermediate feature extraction part 11 is further configured to: perform feature extraction on the initial feature or a feature output by a previous backbone network module, through the first backbone network convolution module and the first separable convolution module respectively, and perform feature merging and a non-linear operation on a feature extracted by the first backbone network convolution module and the first separable convolution module, through the third activation function module, and perform convergence on a feature determined by the non-linear operation, through the second backbone network convolution module, and perform feature extraction on a converged feature through the second separable convolution module to determine the intermediate feature; where a feature channel number of at least one convolution module among the first backbone network convolution module, the first separable convolution module, the second backbone network convolution module, and the second separable convolution module is less than a feature channel number of a corresponding convolution module in the HOP.2 and LOP.2 filters.

In some embodiments, the at least one type of input data includes at least one of a reconstructed picture block, a prediction picture block, boundary strength, a quantization parameter, or mode information; a preset feature channel number of a first convolution module corresponding to the reconstructed picture block is a first value; the first value is less than a feature channel number of a convolution module used for performing feature extraction on the reconstructed picture block in the HOP.2 and LOP.2 filters; and/or a preset feature channel number of a first convolution module corresponding to the prediction picture block is a second value; the second value is less than a feature channel number of a convolution module used for performing feature extraction on the prediction picture block in the HOP.2 and LOP.2 filters; and/or a preset feature channel number of a first convolution module corresponding to the boundary strength is a third value; the third value is less than a feature channel number of a convolution module used for performing feature extraction on the boundary strength in the HOP.2 and LOP.2 filters; and/or a preset feature channel number of a first convolution module corresponding to the quantization parameter is a fourth value; the fourth value is less than a feature channel number of a convolution module used for performing feature extraction on the quantization parameter in the HOP.2 and LOP.2 filters; and/or a preset feature channel number of a first convolution module corresponding to the mode information is a fifth value; the fifth value is less than a feature channel number of a convolution module used for performing feature extraction on the mode information in the HOP.2 and LOP.2 filters.

In some embodiments, a feature channel number corresponding to the first backbone network convolution module is determined based on a preset first feature channel number; the first separable convolution module includes a first convolution kernel and a second convolution kernel; a feature channel number corresponding to the first convolution kernel is determined based on a preset second feature channel number; a feature channel number corresponding to the second convolution kernel is determined based on the preset second feature channel number and a preset third feature channel number; a feature channel number corresponding to the second backbone network convolution module is determined based on the preset first feature channel number and the preset third feature channel number; the second separable convolution module includes a third convolution kernel and a fourth convolution kernel; a feature channel number corresponding to the third convolution kernel is determined based on a preset fourth feature channel number; a feature channel number corresponding to the fourth convolution kernel is determined based on the preset fourth feature channel number; at least one of the preset first feature channel number, the preset second feature channel number, the preset third feature channel number, and the preset fourth feature channel number is less than a feature channel number of a corresponding convolution module in the backbone network module of the HOP.2 and LOP.2 filters.

In some embodiments, the first value is 4; the second value is 2; the third value is 2; the fourth value is 1; the fifth value is 1; the preset feature channel number of the second convolution module is 8; the preset filtering network includes 16 backbone network modules connected in series, and for each backbone network module among the 16 backbone network modules, the preset first feature channel number is 4; the preset second feature channel number is 2; the preset third feature channel number is 4; and the preset fourth feature channel number is 4.

In some embodiments, the preset number of backbone networks include: a preset number of backbone network modules connected in series; the backbone network module includes: a third separable convolution module, a fourth activation function module, and a fourth separable convolution module; the first intermediate feature extraction part 11 is further configured to: perform feature extraction on the initial feature or a feature output by a previous backbone network module through the third separable convolution module, perform non-linear operation on a feature extracted by the third separable convolution module through the fourth activation function module, and perform feature extraction on a feature determined by the non-linear operation through the fourth separable convolution module to determine the intermediate feature.

In some embodiments, the first value is 4; the second value is 2; the third value is 2; the fourth value is 1; the fifth value is 1; the preset feature channel number of the second convolution module is 8; the preset filtering network includes 7 backbone network modules connected in series, and for each backbone network module among the 7 backbone network modules, preset feature channel numbers of convolution kernels in the third separable convolution module and the fourth separable convolution module are determined based on a sixth value.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; the first intermediate feature extraction part 11 is further configured to: perform luma feature extraction based on the initial feature through the first preset number of first backbone network modules, to determine an initial luma feature; where the first backbone network module includes a third backbone network convolution module, a fourth backbone network convolution module, and a fifth separable convolution module; perform feature extraction on the initial luma feature through a sixth separable convolution module on the first network branch, to determine the luma intermediate feature; perform chroma feature extraction on the initial feature through the second preset number of second backbone network modules, to determine an initial chroma feature; where the second backbone network module includes: the third backbone network convolution module, the fourth backbone network convolution module, and the fifth separable convolution module; and perform feature extraction on the initial chroma feature through a seventh separable convolution module on the second network branch, to determine the chroma intermediate feature; where a feature channel number of at least one convolution module among the third backbone network convolution module, the fourth backbone network convolution module, the fifth separable convolution module, the sixth separable convolution module, and the seventh separable convolution module is less than a feature channel number of a corresponding convolution module in the HOP.2 and LOP.2 filters.

In some embodiments, a feature channel number corresponding to the third backbone network convolution module is determined based on a preset first feature channel number; a feature channel number corresponding to the fourth backbone network convolution module is determined based on the preset first feature channel number; a feature channel number corresponding to the fifth separable convolution module is determined based on a preset second feature channel number; a feature channel number corresponding to the sixth separable convolution module is determined based on a preset fifth feature channel number; a feature channel number corresponding to the seventh separable convolution module is determined based on a preset sixth feature channel number; at least one of the preset first feature channel number, the preset second feature channel number, the preset fifth feature channel number, and the preset sixth feature channel number is less than a feature channel number of a corresponding convolution module in a backbone network module of the HOP.2 and LOP.2 filters.

In some embodiments, the first value is 4; the second value is 2; the third value is 1; the fourth value is 1; the fifth value is 1; the second convolution module includes a first merging convolution module and a first downsampling convolution module; a preset feature channel number corresponding to the first merging convolution module is 4; a preset feature channel number corresponding to the first downsampling convolution module is 32; the preset number of backbone networks include: 8 first backbone network modules on a first network branch, and 1 second backbone network module on a second network branch; for the first backbone network module or the second backbone network module, the preset first feature channel number is 32; the preset second feature channel number is 16; the preset fifth feature channel number is 32; and the preset sixth feature channel number is 16.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; the first intermediate feature extraction part 11 is further configured to: perform luma feature extraction based on the initial feature through the first preset number of first backbone network modules, to determine an initial luma feature; where the first backbone network module includes an eighth separable convolution module; perform feature extraction on the initial luma feature through a sixth separable convolution module on the first network branch, to determine the luma intermediate feature; perform chroma feature extraction on the initial feature through the second preset number of second backbone network modules, to determine an initial chroma feature; where the second backbone network module includes a ninth separable convolution module; perform feature extraction on the initial chroma feature through a seventh separable convolution module on the second network branch, to determine the chroma intermediate feature.

In some embodiments, the first value is 8; the second value is 4; the third value is 1; the fourth value is 1; the fifth value is 1; the second convolution module includes a second merging convolution module and a second downsampling convolution module; a preset feature channel number corresponding to the second merging convolution module is 8; a preset feature channel number corresponding to the second downsampling convolution module is 32; the first network branch includes 7 first backbone network modules, and the second network branch includes 2 second backbone network modules; a feature channel number corresponding to the eighth separable convolution module is 32; and a feature channel number corresponding to the ninth separable convolution module is 16.

In some embodiments, the decoder 1 further includes a decoding part; the decoding part is configured to: determine a filtered picture corresponding to a current picture based on the filtered picture block corresponding to the current block; and implement inter prediction decoding by using the filtered picture corresponding to the current picture.

In some embodiments, the decoder 1 further includes a parsing part and a first parameter updating part; the parsing part is configured to parse a bitstream to determine first syntax identification information; and the first parameter updating part is configured to: determine a target quantization offset from at least two candidate base quantization parameters according to the first syntax identification information; and update a quantization parameter corresponding to the current block by using the target quantization offset, to perform filtering based on the reconstructed picture block and an updated quantization parameter through the preset filtering network to determine the filtered picture block.

In some embodiments, the decoder 1 further includes a parsing part and a first transposition part; the parsing part is configured to parse a bitstream to determine second syntax identification information;
the first transposition part is configured to: determine a target transposition angle from at least two preset transposition angles according to the second syntax identification information; and perform transposition processing on the reconstructed picture block according to the target transposition angle, to perform filtering based on a transposed reconstructed picture block through the preset filtering network to determine the filtered picture block.

In some embodiments, the decoder 1 further includes a parsing part and a first Gaussian filtering part;
the parsing part is configured to parse a bitstream to determine third syntax identification information; and
the first Gaussian filtering part is configured to: in response to the third syntax identification information indicating to perform Gaussian filtering on the reconstructed picture block, determine an initial filtered picture block by performing Gaussian filtering on the reconstructed picture block, and perform filtering based on the initial filtered picture block through the preset filtering network, to determine the filtered picture block.

In some embodiments, the decoder 1 further includes a first training part;
the first training part is configured to: perform network training on an initial filtering network by using at least two reconstructed sample picture sets, to determine the preset filtering network; the at least two reconstructed sample picture sets include:
at least two of a reconstructed sample picture set without loop filtering, a reconstructed sample picture set with deblocking filtering, a reconstructed sample picture set with sample adaptive offset filtering, and a reconstructed sample picture set with adaptive loop filtering.

In some embodiments, the first training part is further configured to: perform network training on the initial filtering network by using the at least two reconstructed sample picture sets, to determine at least two candidate filtering networks; the decoder further includes a first network determination part; the first network determination part is configured to: perform filtering based on the reconstructed picture block through the at least two candidate filtering networks, to determine at least two candidate filtered picture blocks corresponding to the at least two candidate filtering networks; determine at least two fourth distortion costs corresponding to the at least two candidate filtered pictures; and determine a filtered picture block corresponding to the current block according to the at least two fourth distortion costs, and/or determine a preset filtering network corresponding to a current picture.

In an actual application of the present disclosure, as shown in FIG. 22, the embodiments of the present disclosure further provide a decoder, including:
a first memory 14 and a first processor 15;
the first memory 14 stores a computer program executable on the first processor 15, and the first processor 15, upon executing the program, implements the video decoding method provided in the embodiments of the present disclosure.

Herein, the first processor 15 may be implemented by software, hardware, firmware, or a combination thereof, and may use a circuit, a single or multiple application specific integrated circuits (ASICs), a single or multiple general-purpose integrated circuits, a single or multiple microprocessors, a single or multiple programmable logic devices, or a combination of the foregoing circuits or devices, or other suitable circuits or devices, so that the first processor 15 may perform the corresponding steps of the video decoding method provided in the embodiments of the present disclosure.

It should be noted that the description of the above decoder embodiments is similar to the description of the above method embodiments, and has beneficial effects similar to those of the method embodiments. For technical details not disclosed in the decoder embodiments of the present disclosure, please refer to the description of the method embodiments of the present disclosure for understanding.

The embodiments of the present disclosure provide an encoder 2, as shown in FIG. 23, including:
a second feature preprocessing part 20, configured to perform feature extraction based on a reconstructed picture block corresponding to a current block through a preprocessing part in a preset filtering network, to determine an initial feature; where a feature channel number of the preprocessing part is a preset value;
a second intermediate feature extraction part 21, configured to perform feature extraction based on the initial feature through a preset number of backbone networks in the preset filtering network, to determine an intermediate feature; where the preset value is less than a feature channel number used for input data feature extraction in HOP.2 and LOP.2 filters; and/or the preset number is less than a number of backbone network layers in HOP.2 and LOP.2 filters; and
a second filtering output part 22, a first filtering output part 12, configured to determine a filtered picture block corresponding to the current block according to the intermediate feature through an output part in the preset filtering network.

In some embodiments, the preprocessing part includes at least one group of first convolution parts, and a second convolution part, the at least one group of first convolution parts corresponds to at least one type of input data; the at least one type of input data at least includes the reconstructed picture block; the first convolution part includes a first convolution module; the second convolution part includes at least one group of second convolution modules and a second activation function module; the preset value includes: a preset feature channel number of at least one first convolution module and/or a preset feature channel number of the second convolution module; the second feature preprocessing part 20 is further configured to: perform feature extraction on the at least one type of input data through the at least one group of first convolution parts, to determine at least one input feature; and merge the at least one input feature through the second convolution part, and perform at least one feature extraction based on a merged input feature to determine the initial feature; where the preset feature channel number of the first convolution module is less than a feature channel number of the first convolution module in the HOP.2 and LOP.2 filters; and/or the preset feature channel number of the second convolution module is less than a feature channel number of a corresponding convolution module in the HOP.2 and LOP.2 filters.

In some embodiments, the preset number of backbone networks include: a preset number of backbone network modules connected in series; the backbone network module includes: a first backbone network convolution module, a first separable convolution module, a third activation function module, a second backbone network convolution module, and a second separable convolution module; the second intermediate feature extraction part 21 is further configured to: perform feature extraction on the initial feature or a feature output by a previous backbone network module, through the first backbone network convolution module and the first separable convolution module respectively, and perform feature merging and a non-linear operation on a feature extracted by the first backbone network convolution module and the first separable convolution module, through the third activation function module, and perform convergence on a feature determined by the non-linear operation, through the second backbone network convolution module, and perform feature extraction on a converged feature through the second separable convolution module to determine the intermediate feature; where a feature channel number of at least one convolution module among the first backbone network convolution module, the first separable convolution module, the second backbone network convolution module, and the second separable convolution module is less than a feature channel number of a corresponding convolution module in the HOP.2 and LOP.2 filters.

In some embodiments, the at least one type of input data includes at least one of a reconstructed picture block, a prediction picture block, boundary strength, a quantization parameter, or mode information; a preset feature channel number of a first convolution module corresponding to the reconstructed picture block is a first value; the first value is less than a feature channel number of a convolution module used for performing feature extraction on the reconstructed picture block in the HOP.2 and LOP.2 filters; and/or a preset feature channel number of a first convolution module corresponding to the prediction picture block is a second value; the second value is less than a feature channel number of a convolution module used for performing feature extraction on the prediction picture block in the HOP.2 and LOP.2 filters; and/or a preset feature channel number of a first convolution module corresponding to the boundary strength is a third value; the third value is less than a feature channel number of a convolution module used for performing feature extraction on the boundary strength in the HOP.2 and LOP.2 filters; and/or a preset feature channel number of a first convolution module corresponding to the quantization parameter is a fourth value; the fourth value is less than a feature channel number of a convolution module used for performing feature extraction on the quantization parameter in the HOP.2 and LOP.2 filters; and/or a preset feature channel number of a first convolution module corresponding to the mode information is a fifth value; the fifth value is less than a feature channel number of a convolution module used for performing feature extraction on the mode information in the HOP.2 and LOP.2 filters.

In some embodiments, a feature channel number corresponding to the first backbone network convolution module is determined based on a preset first feature channel number; the first separable convolution module includes a first convolution kernel and a second convolution kernel; a feature channel number corresponding to the first convolution kernel is determined based on a preset second feature channel number; a feature channel number corresponding to the second convolution kernel is determined based on the preset second feature channel number and a preset third feature channel number; a feature channel number corresponding to the second backbone network convolution module is determined based on the preset first feature channel number and the preset third feature channel number; the second separable convolution module includes a third convolution kernel and a fourth convolution kernel; a feature channel number corresponding to the third convolution kernel is determined based on a preset fourth feature channel number; a feature channel number corresponding to the fourth convolution kernel is determined based on the preset fourth feature channel number; at least one preset feature channel number among the preset first feature channel number, the preset second feature channel number, the preset third feature channel number, and the preset fourth feature channel number is less than a feature channel number of a corresponding convolution module in the backbone network module of the HOP.2 and LOP.2 filters.

In some embodiments, the first value is 4; the second value is 2; the third value is 2; the fourth value is 1; the fifth value is 1; the preset feature channel number of the second convolution module is 8; the preset filtering network includes 16 backbone network modules connected in series, and for each backbone network module among the 16 backbone network modules, the preset first feature channel number is 4; the preset second feature channel number is 2; the preset third feature channel number is 4; and the preset fourth feature channel number is 4.

In some embodiments, the preset number of backbone networks include: a preset number of backbone network modules connected in series; the backbone network module includes: a third separable convolution module, a fourth activation function module, and a fourth separable convolution module; the second intermediate feature extraction part 21 is further configured to: perform feature extraction on the initial feature or a feature output by a previous backbone network module through the third separable convolution module, perform non-linear operation on a feature extracted by the third separable convolution module through the fourth activation function module, and perform feature extraction on a feature determined by the non-linear operation through the fourth separable convolution module to determine the intermediate feature.

In some embodiments, the first value is 4; the second value is 2; the third value is 2; the fourth value is 1; the fifth value is 1; the preset feature channel number of the second convolution module is 8; the preset filtering network includes 7 backbone network modules connected in series, and for each backbone network module among the 7 backbone network modules, feature channel numbers of convolution kernels in the third separable convolution module and the fourth separable convolution module are determined based on a feature channel number of the initial feature.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; the second intermediate feature extraction part 21 is further configured to: perform luma feature extraction based on the initial feature through the first preset number of first backbone network modules, to determine an initial luma feature; where the first backbone network module includes a third backbone network convolution module, a fourth backbone network convolution module, and a fifth separable convolution module; perform feature extraction on the initial luma feature through a sixth separable convolution module on the first network branch, to determine the luma intermediate feature; perform chroma feature extraction on the initial feature through the second preset number of second backbone network modules, to determine an initial chroma feature; where the second backbone network module includes: the third backbone network convolution module, the fourth backbone network convolution module, and the fifth separable convolution module; and perform feature extraction on the initial chroma feature through a seventh separable convolution module on the second network branch, to determine the chroma intermediate feature; where a feature channel number of at least one convolution module among the third backbone network convolution module, the fourth backbone network convolution module, the fifth separable convolution module, the sixth separable convolution module, and the seventh separable convolution module is less than a feature channel number of a corresponding convolution module in the HOP.2 and LOP.2 filters.

In some embodiments, a feature channel number corresponding to the third backbone network convolution module is determined based on a preset first feature channel number; a feature channel number corresponding to the fourth backbone network convolution module is determined based on the preset first feature channel number; a feature channel number corresponding to the fifth separable convolution module is determined based on a preset second feature channel number; a feature channel number corresponding to the sixth separable convolution module is determined based on a preset fifth feature channel number; a feature channel number corresponding to the seventh separable convolution module is determined based on a preset sixth feature channel number; at least one of the preset first feature channel number, the preset second feature channel number, the preset fifth feature channel number, and the preset sixth feature channel number is less than a feature channel number of a corresponding convolution module in a backbone network module of the HOP.2 and LOP.2 filters.

In some embodiments, the first value is 4; the second value is 2; the third value is 1; the fourth value is 1; the fifth value is 1; the preset feature channel number of the second convolution module is 4; the preset number of backbone networks include: 8 first backbone network modules on a first network branch, and 8 second backbone network module on a second network branch; for the first backbone network module or the second backbone network module, the preset first feature channel number is 32; the preset second feature channel number is 16; the preset fifth feature channel number is 32; and the preset sixth feature channel number is 16.

In some embodiments, the preset number of backbone networks include: a first preset number of first backbone network modules on a first network branch, and a second preset number of second backbone network modules on a second network branch; the intermediate feature includes: a luma intermediate feature and a chroma intermediate feature; the second intermediate feature extraction part 21 is further configured to: perform luma feature extraction based on the initial feature through the first preset number of first backbone network modules, to determine an initial luma feature; where the first backbone network module includes an eighth separable convolution module; perform feature extraction on the initial luma feature through a sixth separable convolution module on the first network branch, to determine the luma intermediate feature; perform chroma feature extraction on the initial feature through the second preset number of second backbone network modules, to determine an initial chroma feature; where the second backbone network module includes a ninth separable convolution module; perform feature extraction on the initial chroma feature through a seventh separable convolution module on the second network branch, to determine the chroma intermediate feature.

In some embodiments, the first value is 8; the second value is 4; the third value is 1; the fourth value is 1; the fifth value is 1; the preset feature channel number of the second convolution module is 8; the first network branch includes 7 first backbone network modules, and the second network branch includes 7 second backbone network modules; a feature channel number corresponding to the eighth separable convolution module is determined based on the feature channel number of the initial feature; and a feature channel number corresponding to the ninth separable convolution module is less than the feature channel number corresponding to the eighth separable convolution module.

In some embodiments, the encoder 2 further includes: an encoding part; the encoding part is configured to: determine a filtered picture corresponding to a current picture based on the filtered picture block corresponding to the current block; and implement inter prediction encoding by using the filtered picture corresponding to the current picture.

In some embodiments, the intermediate feature includes: at least two intermediate features, the at least two intermediate features correspond to at least two initial features; the at least two initial features are determined by performing feature extraction based on the reconstructed picture block through the preprocessing part, in combination with at least two candidate base quantization parameters corresponding to the current block, respectively; the at least two candidate base quantization parameters are determined by a base quantization parameter corresponding to the current block and at least two candidate quantization offsets;
the second filtering output part 22 is further configured to: determine at least two candidate filtered picture blocks corresponding to the current block according to the at least two intermediate features, through the output part in the preset filtering network; determine at least two first distortion costs corresponding to the at least two candidate filtered picture blocks; and determine the filtered picture block corresponding to the current block according to the at least two first distortion costs.

In some embodiments, the encoder 2 further includes an encoding part, the encoding part is configured to: determine a target quantization offset among the at least two candidate quantization offsets according to the at least two first distortion costs, and determine first syntax identification information corresponding to the target quantization offset; and perform entropy encoding on the first syntax identification information, and write obtained encoded bits into a bitstream.

In some embodiments, the intermediate feature includes: at least two intermediate features; the at least two intermediate features correspond to at least two reconstructed picture blocks; the at least two reconstructed picture blocks are determined by performing transposition processing on the reconstructed picture block through at least two preset transposition angles;
the second filtering output part 22 is further configured to: determine at least two candidate filtered picture blocks corresponding to the current block according to the at least two intermediate features, through the output part in the preset filtering network; determine at least two second distortion costs corresponding to the at least two candidate filtered picture blocks; determine the filtered picture block corresponding to the current block according to the at least two second distortion costs.

In some embodiments, the encoder 2 further includes an encoding part, the encoding part is configured to: determine a target transposition angle among the at least two preset transposition angles according to the at least two second distortion costs, and determine second syntax identification information corresponding to the target transposition angle; and perform entropy encoding on the second syntax identification information, and write obtained encoded bits into a bitstream.

In some embodiments, the encoder 2 further includes a second training part; the second training part is configured to: perform network training on an initial filtering network by a reconstructed sample picture block set including reconstructed sample picture blocks with the at least two preset transposition angles, to determine the preset filtering network.

In some embodiments, the intermediate feature includes: a first intermediate feature and a second intermediate feature; the first intermediate feature corresponds to a first reconstructed picture block; the second intermediate feature corresponds to a second reconstructed picture block; the first reconstructed picture block includes an original reconstructed picture block corresponding to the current block; the second reconstructed picture block includes an initial filtered picture block determined by performing Gaussian filtering on the original reconstructed picture block; and
the second filtering output part 22 is further configured to: determine a first candidate filtered picture block corresponding to the current block according to the first intermediate feature through the output part in the preset filtering network; and determine a second candidate filtered picture block corresponding to the current block according to the second intermediate feature; determine a third distortion cost corresponding to the first candidate filtered picture block, and a fourth distortion cost corresponding to the second candidate filtered picture block; and determine the filtered picture block corresponding to the current block according to the third distortion cost and the fourth distortion cost.

In some embodiments, the encoder 2 further includes an encoding part, the encoding part is configured to: determine third syntax identification information according to the third distortion cost and the fourth distortion cost; where the third syntax identification information indicates whether to perform Gaussian filtering on the current block; perform entropy encoding on the third syntax identification information, and write obtained encoded bits into a bitstream.

In some embodiments, the encoder 2 further includes a second training part; the second training part is configured to: perform network training on an initial filtering network by using at least two reconstructed sample picture sets, to determine the preset filtering network; the at least two reconstructed sample picture sets include:
at least two of a reconstructed sample picture set without loop filtering, a reconstructed sample picture set with deblocking filtering, a reconstructed sample picture set with sample adaptive offset filtering, and a reconstructed sample picture set with adaptive loop filtering.

In some embodiments, the second training part is further configured to: perform network training on the initial filtering network by using the at least two reconstructed sample picture sets, to determine at least two candidate filtering networks;
the encoder 2 further includes a second network determination part; the second network determination part is configured to: perform filtering based on the reconstructed picture block through the at least two candidate filtering networks, to determine at least two candidate filtered picture blocks corresponding to the at least two candidate filtering networks; determine at least two fourth distortion costs corresponding to the at least two candidate filtered pictures; and determine a filtered picture block corresponding to the current block according to the at least two fourth distortion costs, and/or determine a preset filtering network corresponding to a current picture.

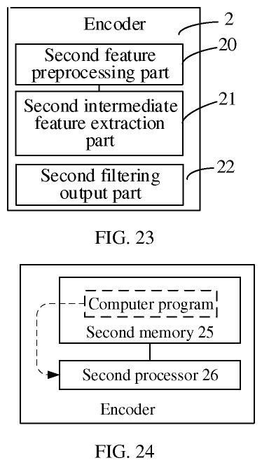

In an actual application, as shown in FIG. 24, the embodiments of the present disclosure further provide an encoder, including:
a second memory 25 and a second processor 26;
the second memory 25 stores a computer program executable on the second processor 26, and the second processor 26, upon executing the program, implements the video encoding method provided in the embodiments of the present disclosure.

It should be noted that the description of the above encoder embodiments is similar to the description of the above method embodiments, and has beneficial effects similar to those of the method embodiments. For technical details not disclosed in the encoder embodiments of the present disclosure, please refer to the description of the method embodiments of the present disclosure for understanding.

The embodiments of the present disclosure provide a bitstream, where the bitstream is generated by performing bit encoding according to to-be-encoded information; where the to-be-encoded information at least includes at least one of.
encoding information of a current picture;
where the encoding information of the current picture is determined by performing inter prediction based on a historical filtered picture block; the historical filtered picture block is determined by filtering a historical block in a historical picture through a preset filtering network, including:
performing feature extraction based on a historical reconstructed picture block corresponding to the historical block through a preprocessing part in the preset filtering network, to determine a historical initial feature; where a feature channel number of the preprocessing part is a preset value;
performing feature extraction based on the historical initial feature through a preset number of backbone networks in the preset filtering network, to determine a historical intermediate feature; where the preset value is less than a feature channel number used for input data feature extraction in HOP.2 and LOP.2 filters; and/or the preset number is less than a number of backbone network layers in the HOP.2 and LOP.2 filters; and
determining the historical filtered picture block according to the historical intermediate feature through an output part in the preset filtering network.

The embodiments of the present disclosure provide a non-transitory computer-readable storage medium having a computer program stored thereon, where the computer program, when executed by the first processor, implements the video decoding method provided in the embodiments of the present disclosure; or, the computer program, when executed by the second processor, implements the video encoding method provided in the embodiments of the present disclosure.

The components in the embodiments of the present disclosure may be integrated in a processing unit, or each unit may exist physically alone, or two or more units may be integrated in a unit. The above integrated unit may be implemented in the form of hardware or in the form of a software functional module.

If the integrated unit is implemented in the form of a software functional module and is not sold or used as an independent product, it may be stored in a non-transitory computer-readable storage medium. Based on such an understanding, the technical solutions of the embodiments essentially, or a part contributing to the prior art, or all or a part of the technical solutions may be embodied in the form of a software product. The computer software product is stored in a non-transitory computer-readable storage medium and includes several instructions to enable a computer device (which may be a personal computer, a server, or a network device, etc.) or a processor to perform all or a part of the steps of the methods described in the embodiments. The aforementioned non-transitory computer-readable storage medium includes: various media that may store program codes, such as ferromagnetic random access memory (FRAM), Read Only Memory (ROM), Programmable Read-Only Memory (PROM), Erasable Programmable Read-Only Memory (EPROM), Electrically Erasable Programmable Read-Only Memory (EEPROM), Flash Memory, magnetic surface memory, optical disk, or Compact Disc Read-Only Memory (CD-ROM), etc., which are not limited in the embodiments of the present disclosure.

The above descriptions are only implementations of the present disclosure, but the protection scope of the present disclosure is not limited thereto. Any person familiar with the technical field may easily think of changes or substitutions within the technical scope disclosed in the present disclosure, which should be covered in the protection scope of the present disclosure. Therefore, the protection scope of the present disclosure should be based on the protection scope of the claims.

### INDUSTRIAL APPLICABILITY

The embodiments of the present disclosure provide a video encoding method, a video decoding method, a decoder, an encoder, and a computer-readable storage medium. In a preset filtering network, a feature channel number of a preprocessing part is a preset value, and the preset value is less than a feature channel number used for input data feature extraction in HOP.2 and LOP.2 filters; and/or a number of backbone networks is a preset number, and the preset number is less than a number of backbone network layers in the HOP.2 and LOP.2 filters. In this way, by reducing the feature channel number of the preprocessing part and/or reducing the depth of the backbone network layers, the model complexity is effectively reduced, which is beneficial for applying a neural network-based loop filtering tool on more terminals, thereby improving the widespread application of the neural network-based filtering solution. Moreover, it has been verified through experiments that the use of the preset filtering network of the embodiments of the present disclosure may still guarantee relatively high encoding and decoding performance.

What is claimed is:

1. A video decoding method, performed by a decoder, and comprising:
performing feature extraction based on a reconstructed picture block corresponding to a current block through a preprocessing part in a preset filtering network, to determine an initial feature; wherein a feature channel number of the preprocessing part is a preset value;
performing feature extraction based on the initial feature through a preset number of backbone networks in the preset filtering network, to determine an intermediate feature; and
determining a filtered picture block corresponding to the current block according to the intermediate feature through an output part in the preset filtering network.

2. The method according to claim 1, wherein the preset value is less than a feature channel number used for input data feature extraction in High Operation Point (HOP.2) and Low Operation Point (LOP.2) filters; and/or the preset number is less than a number of backbone network layers in HOP.2 and LOP.2 filters.

3. The method according to claim 1, wherein the preprocessing part comprises at least one group of first convolution parts, and a second convolution part, and the at least one group of first convolution parts corresponds to at least one type of input data; the at least one type of input data at least comprises the reconstructed picture block; a first convolution part comprises a first convolution module; the second convolution part comprises at least one group of second convolution modules and a second activation function module; the preset value comprises: a preset feature channel number of at least one first convolution module and/or a preset feature channel number of the second convolution module; and performing feature extraction based on the reconstructed picture block corresponding to the current block through the preprocessing part in the preset filtering network, to determine the initial feature, comprises:
performing feature extraction on the at least one type of input data through the at least one group of first convolution parts, to determine at least one input feature; and
merging the at least one input feature through the second convolution part, and performing at least one feature extraction based on a merged input feature to determine the initial feature;
wherein the preset feature channel number of the first convolution module is less than a feature channel number of the first convolution module in HOP.2 and LOP.2 filters; and/or the preset feature channel number of the second convolution module is less than a feature channel number of a corresponding convolution module in the HOP.2 and LOP.2 filters.

4. The method according to claim 1, wherein the preset number of backbone networks comprise: a preset number of backbone network modules connected in series; a backbone network module comprises: a first backbone network convolution module, a first separable convolution module, a third activation function module, a second backbone network convolution module, and a second separable convolution module; and performing feature extraction based on the initial feature through the preset number of backbone networks in the preset filtering network, to determine the intermediate feature, comprises:
performing feature extraction on the initial feature or a feature output by a previous backbone network module, through the first backbone network convolution module and the first separable convolution module respectively, and performing feature merging and a non-linear operation on a feature extracted by the first backbone network convolution module and the first separable convolution module, through the third activation function module, and performing convergence on a feature determined by the non-linear operation, through the second backbone network convolution module, and performing feature extraction on a converged feature through the second separable convolution module to determine the intermediate feature;
wherein a feature channel number of at least one convolution module among the first backbone network convolution module, the first separable convolution module, the second backbone network convolution module, and the second separable convolution module is less than a feature channel number of a corresponding convolution module in HOP.2 and LOP.2 filters.

5. The method according to claim 3, wherein the at least one type of input data comprises at least one of a reconstructed picture block, a prediction picture block, boundary strength, a quantization parameter, or mode information;
a preset feature channel number of a first convolution module corresponding to the reconstructed picture block is a first value, and the first value is less than a feature channel number of a convolution module used for performing feature extraction on the reconstructed picture block in HOP.2 and LOP.2 filters;
and/or
a preset feature channel number of a first convolution module corresponding to the prediction picture block is a second value, and the second value is less than a feature channel number of a convolution module used for performing feature extraction on the prediction picture block in the HOP.2 and LOP.2 filters;
and/or
a preset feature channel number of a first convolution module corresponding to the boundary strength is a third value, and the third value is less than a feature channel number of a convolution module used for performing feature extraction on the boundary strength in the HOP.2 and LOP.2 filters;
and/or
a preset feature channel number of a first convolution module corresponding to the quantization parameter is a fourth value, and the fourth value is less than a feature channel number of a convolution module used for performing feature extraction on the quantization parameter in the HOP.2 and LOP.2 filters;
and/or
a preset feature channel number of a first convolution module corresponding to the mode information is a fifth value, and the fifth value is less than a feature channel number of a convolution module used for performing feature extraction on the mode information in the HOP.2 and LOP.2 filters.

6. The method according to claim 4, wherein
a feature channel number corresponding to the first backbone network convolution module is determined based on a preset first feature channel number;
the first separable convolution module comprises a first convolution kernel and a second convolution kernel; a feature channel number corresponding to the first convolution kernel is determined based on a preset second feature channel number, and a feature channel number corresponding to the second convolution kernel is determined based on the preset second feature channel number and a preset third feature channel number;
a feature channel number corresponding to the second backbone network convolution module is determined based on the preset first feature channel number and the preset third feature channel number;
the second separable convolution module comprises a third convolution kernel and a fourth convolution kernel; a feature channel number corresponding to the third convolution kernel is determined based on a preset fourth feature channel number, and a feature channel number corresponding to the fourth convolution kernel is determined based on the preset fourth feature channel number; and
at least one of the preset first feature channel number, the preset second feature channel number, the preset third feature channel number, and the preset fourth feature channel number is less than a feature channel number of a corresponding convolution module in a backbone network module of the HOP.2 and LOP.2 filters;
wherein the preset filtering network comprises 16 backbone network modules connected in series, and for each backbone network module among the 16 backbone network modules, the preset first feature channel number is 4; the preset second feature channel number is 2; the preset third feature channel number is 4; and the preset fourth feature channel number is 4.

7. The method according to claim 5, wherein the first value is 4; the second value is 2; the third value is 2; the fourth value is 1; the fifth value is 1; and the preset feature channel number of the second convolution module is 8; or wherein the first value is 4; the second value is 2; the third value is 1; the fourth value is 1; the fifth value is 1; the second convolution module comprises a first merging convolution module and a first downsampling convolution module; a preset feature channel number corresponding to the first merging convolution module is 4; a preset feature channel number corresponding to the first downsampling convolution module is 32; or
wherein the first value is 8; the second value is 4; the third value is 1; the fourth value is 1; the fifth value is 1; the second convolution module comprises a second merging convolution module and a second downsampling convolution module; a preset feature channel number corresponding to the second merging convolution module is 8; a preset feature channel number corresponding to the second downsampling convolution module is 32.

8. The method according to claim 1, wherein the preset number of backbone networks comprise: a preset number of backbone network modules connected in series; a backbone network module comprises: a third separable convolution module, a fourth activation function module, and a fourth separable convolution module; and performing feature extraction based on the initial feature through the preset number of backbone networks in the preset filtering network, to determine the intermediate feature, comprises:
performing feature extraction on the initial feature or a feature output by a previous backbone network module through the third separable convolution module, performing non-linear operation on a feature extracted by the third separable convolution module through the fourth activation function module, and performing feature extraction on a feature determined by the non-linear operation through the fourth separable convolution module to determine the intermediate feature.

9. The method according to claim 8, wherein the preset filtering network comprises 7 backbone network modules connected in series, and for each backbone network module among the 7 backbone network modules, and preset feature channel numbers of convolution kernels in the third separable convolution module and the fourth separable convolution module are determined based on a sixth value.

10. The method according to claim 1, wherein the preset number of backbone networks comprise: a first preset number of first backbone network modules on a first network branch, and a second preset number of second backbone network modules on a second network branch; the intermediate feature comprises: a luma intermediate feature and a chroma intermediate feature; and performing feature extraction based on the initial feature through the preset number of backbone networks in the preset filtering network, to determine the intermediate feature, comprises:
performing luma feature extraction based on the initial feature through the first preset number of first backbone network modules, to determine an initial luma feature; wherein a first backbone network module comprises a third backbone network convolution module, a fourth backbone network convolution module, and a fifth separable convolution module;
performing feature extraction on the initial luma feature through a sixth separable convolution module on the first network branch, to determine the luma intermediate feature;
performing chroma feature extraction on the initial feature through the second preset number of second backbone network modules, to determine an initial chroma feature; wherein a second backbone network module comprises: the third backbone network convolution module, the fourth backbone network convolution module, and the fifth separable convolution module; and
performing feature extraction on the initial chroma feature through a seventh separable convolution module on the second network branch, to determine the chroma intermediate feature;
wherein a feature channel number of at least one convolution module among the third backbone network convolution module, the fourth backbone network convolution module, the fifth separable convolution module, the sixth separable convolution module, and the seventh separable convolution module is less than a feature channel number of a corresponding convolution module in HOP.2 and LOP.2 filters.

11. The method according to claim 10, wherein
a feature channel number corresponding to the third backbone network convolution module is determined based on a preset first feature channel number;
a feature channel number corresponding to the fourth backbone network convolution module is determined based on the preset first feature channel number;
a feature channel number corresponding to the fifth separable convolution module is determined based on a preset second feature channel number;
a feature channel number corresponding to the sixth separable convolution module is determined based on a preset fifth feature channel number;
a feature channel number corresponding to the seventh separable convolution module is determined based on a preset sixth feature channel number;
at least one of the preset first feature channel number, the preset second feature channel number, the preset fifth feature channel number, and the preset sixth feature channel number is less than a feature channel number of a corresponding convolution module in a backbone network module of the HOP.2 and LOP.2 filters.

12. The method according to claim 11, wherein
the preset number of backbone networks comprise: 8 first backbone network modules on a first network branch, and 1 second backbone network module on a second network branch; for a first backbone network module or a second backbone network module, the preset first feature channel number is 32; the preset second feature channel number is 16; the preset fifth feature channel number is 32; and the preset sixth feature channel number is 16.

13. The method according to claim 1, wherein the preset number of backbone networks comprise: a first preset number of first backbone network modules on a first network branch, and a second preset number of second backbone network modules on a second network branch; the intermediate feature comprises: a luma intermediate feature and a chroma intermediate feature; and performing feature extraction based on the initial feature through the preset number of backbone networks in the preset filtering network, to determine the intermediate feature, comprises:
performing luma feature extraction based on the initial feature through the first preset number of first backbone network modules, to determine an initial luma feature; wherein a first backbone network module comprises an eighth separable convolution module;
performing feature extraction on the initial luma feature through a sixth separable convolution module on the first network branch, to determine the luma intermediate feature;
performing chroma feature extraction on the initial feature through the second preset number of second backbone network modules, to determine an initial chroma feature; wherein a second backbone network module comprises a ninth separable convolution module; and
performing feature extraction on the initial chroma feature through a seventh separable convolution module on the second network branch, to determine the chroma intermediate feature.

14. The method according to claim 13, wherein
the first network branch comprises 7 first backbone network modules, and the second network branch comprises 2 second backbone network modules; a feature channel number corresponding to the eighth separable convolution module is 32; and a feature channel number corresponding to the ninth separable convolution module is 16.

15. The method according to claim 1, wherein the method further comprises:
parsing a bitstream to determine first syntax identification information;
determining a target quantization offset from at least two candidate base quantization parameters according to the first syntax identification information; and
updating a quantization parameter corresponding to the current block by using the target quantization offset, to perform filtering based on the reconstructed picture block and an updated quantization parameter through the preset filtering network to determine the filtered picture block.

16. The method according to claim 1, wherein the method further comprises:
parsing a bitstream to determine second syntax identification information;
determining a target transposition angle from at least two preset transposition angles according to the second syntax identification information; and
performing transposition processing on the reconstructed picture block according to the target transposition angle, to perform filtering based on a transposed reconstructed picture block through the preset filtering network to determine the filtered picture block.

17. The method according to claim 1, wherein the method further comprises:
parsing a bitstream to determine third syntax identification information; and
in response to the third syntax identification information indicating to perform Gaussian filtering on the reconstructed picture block, determining an initial filtered picture block by performing Gaussian filtering on the reconstructed picture block, and performing filtering based on the initial filtered picture block through the preset filtering network, to determine the filtered picture block.

18. The method according to claim 1, wherein the method further comprises:
performing network training on an initial filtering network by using at least two reconstructed sample picture sets, to determine the preset filtering network;
wherein the at least two reconstructed sample picture sets comprise:
at least two of a reconstructed sample picture set without loop filtering, a reconstructed sample picture set with deblocking filtering, a reconstructed sample picture set with sample adaptive offset filtering, and a reconstructed sample picture set with adaptive loop filtering.

19. A video encoding method, performed by an encoder, and comprising:
performing feature extraction based on a reconstructed picture block corresponding to a current block through a preprocessing part in a preset filtering network, to determine an initial feature; wherein a feature channel number of the preprocessing part is a preset value;
performing feature extraction based on the initial feature through a preset number of backbone networks in the preset filtering network, to determine an intermediate feature; and
determining a filtered picture block corresponding to the current block according to the intermediate feature through an output part in the preset filtering network.

20. A non-transitory computer-readable storage medium, having a computer program and a bitstream stored thereon, wherein the computer program, when executed by a processor, causes the processor to perform the following steps to generate the bitstream:
performing feature extraction based on a reconstructed picture block corresponding to a current block through a preprocessing part in a preset filtering network, to determine an initial feature; wherein a feature channel number of the preprocessing part is a preset value;
performing feature extraction based on the initial feature through a preset number of backbone networks in the preset filtering network, to determine an intermediate feature; and
determining a filtered picture block corresponding to the current block according to the intermediate feature through an output part in the preset filtering network.
